(19) United States
(12) Patent Application Publication
(10) Pub. No.: US 2015/0006214 A1
(43) Pub. Date: Jan. 1, 2015

(54) METHODS AND SYSTEMS FOR UNDERSTANDING THE ALLOCATION OF RESOURCES TO GOALS

(71) Applicant: HRM Direct, Inc., Boston, MA (US)

(72) Inventors: Andre G. Lavoie, San Francisco, CA (US); Colin W. Kingsbury, Boston, MA (US)

(21) Appl. No.: 14/312,734

(22) Filed: Jun. 24, 2014

Related U.S. Application Data
(60) Provisional application No. 61/841,658, filed on Jul. 1, 2013.

(51) Int. Cl. G06Q 10/06

(52) U.S. Cl. CPC G06Q 10/063118
USPC 705/7.17

(57) ABSTRACT

A method includes associating, by a computing device, at least one employee with each of a plurality of goals. The method includes determining, by the computing device, an allocation of personal effort of the at least one employee toward each of the plurality of goals. The method includes determining, by the computing device, a corporate allocation of effort for each goal of the plurality of goals, using the determined allocation of effort for the at least one employee. The method includes providing, by the computing device, to a user, a visualization of the determined corporate allocation of effort.

### CROSS-REFERENCE TO RELATED APPLICATIONS

This application claims priority from U.S. Provisional Patent Application No. 61/841,658, filed on Jul. 1, 2013, entitled “Methods and Systems for Real-Time Measurement of Progress on Implementing a Corporate Objective,” which is hereby incorporated by reference.

### BACKGROUND

The disclosure relates to understanding the allocation of resources to goals. More particularly, the methods and systems described herein relate to real-time measurement of progress on employee tasks, goals, and projects aligned to a corporate objective and using the measured progress to automatically determine a level of corporate-wide allocation of effort.

In conventional systems for workflow management, workflows (or actions) are used to alter a state of an entity (e.g., changing a “Sales Lead” to a “Client”) and to enforce business rules and processes associated with changes of state. Conventional systems typically present users with a limited set of largely predefined entities, states, and workflows so as to minimize the cost of setting up and deploying the system. This process typically requires customers to work around design choices that do not necessarily align well with their actual business practices. The gap between the assumptions made by the system architect and the actual nature of the business being modeled forces customers to make business process changes in order to work within the system or to perform additional processes or data analysis outside of the system to obtain the desired result. Alternatively, users may choose to develop a customized system that is designed to align very closely to their current business practices and goals, but many companies lack the necessary skill or resources to build such a system or to provide adequate ongoing support.

### BRIEF SUMMARY

In one aspect, the methods and systems described herein provide functionality allowing business users to quickly define new entities, states, and workflows associated with a company's strategic goals. In contrast to existing systems where the design process begins by determining the data entities and then creating tables to store attributes associated with those entities, the methods and systems described herein enable users to begin by defining strategic objectives and goals for the business and then defining the entities which are measured or manipulated in the process of accomplishing those goals. Rather than defining goals externally from the business's information systems (which do not necessarily have an implicit or explicit understanding of those goals), the methods and systems described herein allow users to define the entities and processes based on the goals associated with them.

In one aspect, a method for understanding the allocation of resources to goals includes associating, by a computing device, at least one employee with each of a plurality of goals. The method includes determining, by the computing device, an allocation of personal effort of the at least one employee toward each of the plurality of goals. The method includes determining, by the computing device, a corporate allocation of effort for each goal of the plurality of goals, using the determined allocation of effort for the at least one employee. The method includes providing, by the computing device, to a user, a visualization of the determined corporate allocation of effort.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2A is a block diagram depicting an embodiment of a system for real-time measurement of progress on implementing a corporate objective;

FIG. 2B is a block diagram depicting one embodiment of a user interface with which to create a goal;

FIG. 2C is a block diagram depicting one embodiment of a user interface with which to associate a goal with a corporate objective;

FIG. 2D is a block diagram depicting one embodiment of a user interface with which a user may associate a task with a goal;

FIG. 2E is a block diagram depicting one embodiment of a user interface with which to associate data with data objects;

FIG. 2F is a block diagram depicting one embodiment of a user interface with which users may assign or modify levels of priority between objects;

FIG. 2G is a block diagram depicting one embodiment of a user interface for associating users with objects;

FIGS. 2H and 21 are block diagrams depicting embodiments of user interfaces with which to monitor a level of progress of users associated with objects;

FIG. 2J is a block diagram depicts one embodiment of a user interface with which users may provide or modify a status of an object;

FIG. 2K is a block diagram depicting one embodiment of a data structure representing an object;

FIG. 2L is a block diagram depicting embodiments of a user interface for associating a goal with an object upon which completion of the goal depends;

FIG. 2M is a block diagram depicting one embodiment of a user interface for viewing a plurality of objects;

FIG. 2N is a block diagram depicting one embodiment of a user interface for interacting with a user associated with an object;

FIGS. 2O-2P are block diagrams depicting embodiments of user interfaces for viewing one or more goals;

FIGS. 2Q-2S are block diagrams depicting embodiments of user interfaces for viewing alignment of objects throughout an organization;

FIG. 3A is a flow diagram depicting an embodiment of a method for real-time measurement of progress on implementing a corporate objective;

FIG. 3B is a block diagram depicting embodiments of user interfaces with which users may instruct the computing device to request periodic status updates;

FIGS. 3C-3D are block diagrams depicting embodiments of a user interface for viewing one or more notifications;

FIG. 3E is a block diagram depicting one embodiment of a user interface for receiving text to associate with an object;

FIG. 4A is a flow diagram depicting an embodiment of a method for real-time alignment of a job opportunity to a corporate objective;

FIG. 4B is a block diagram depicting one embodiment of a user interface with which a user may associate objects with a new hire;

FIG. 4C is a block diagram depicting one embodiment of a user interface for associating a goal with an employee review;

FIG. 4D is a block diagram depicting one embodiment of a user interface with which users may provide a review of an object;

FIG. 4E is a block diagram depicting one embodiment of a user interface providing a data visualization with which users may view goals and performance by users associated with those goals; and

FIG. 5 is a flow diagram depicting one embodiment of a method for allocating priorities to goals.

### DETAILED DESCRIPTION

In some embodiments, the methods and systems described herein provide functionality for real-time measurement of progress on implementing a corporate objective. Before describing these methods and systems in detail, however, a description is provided of a network in which such methods and systems may be implemented.

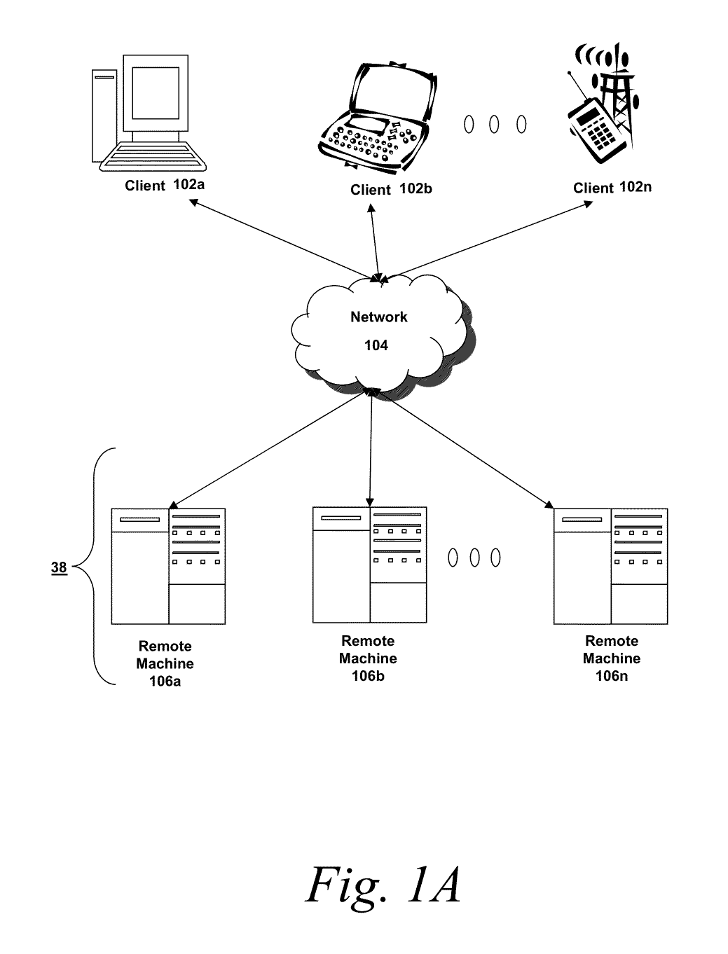

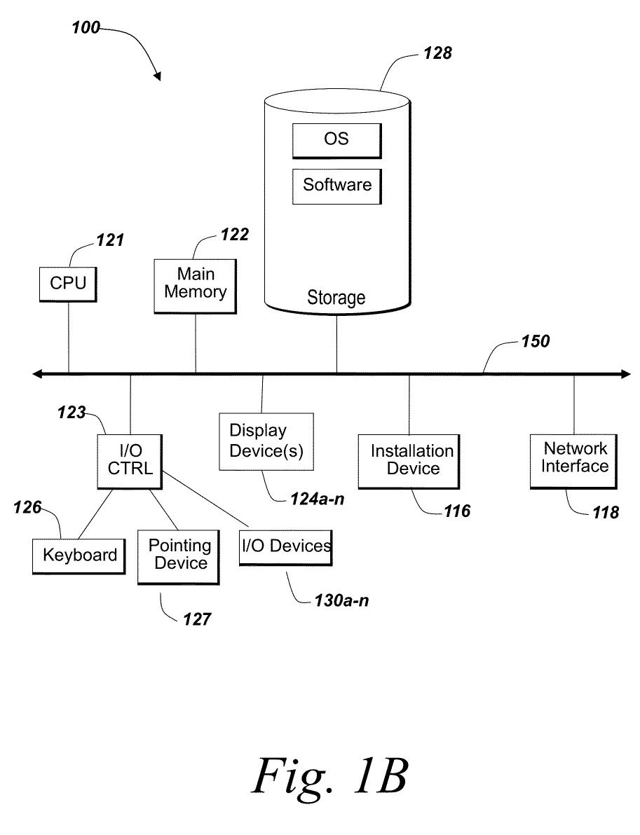

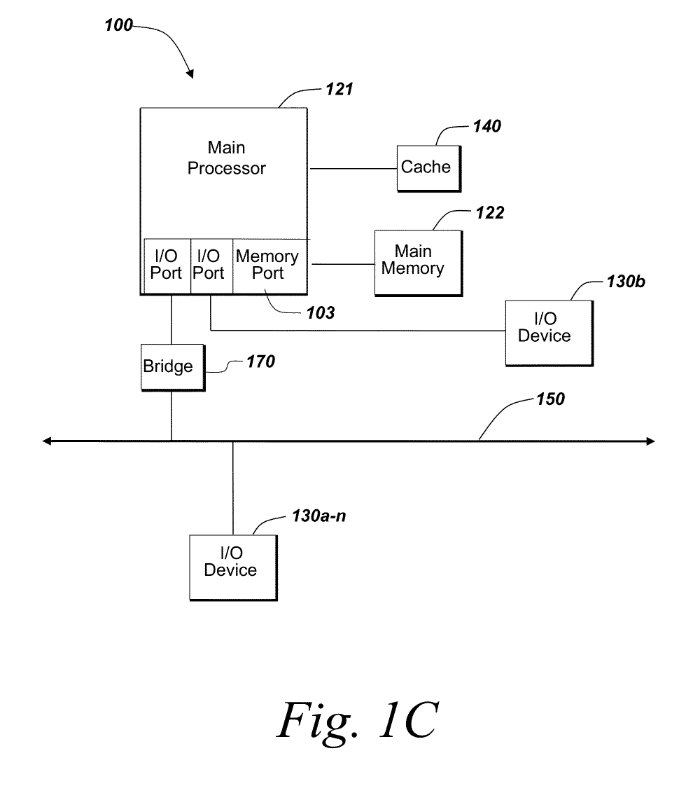

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides the functionality of a web server. In some embodiments, a web server 106 comprises an open-source web server such as the APACHE servers maintained by the Apache Software Foundation of Delaware. In other embodiments, the web server executes proprietary software such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif. In further embodiments, a computing device 106 executes self-replication software. In one of these embodiments, execution of the self-replication software allows a computing device 106a to direct a second computing device 106b to provide a copy of data stored by the computing device 106. For example, the computing device 106a may provide access to a web site and, upon execution of the self-replication software, direct the second computing device 106b to provide access to a copy of the web site.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140, in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. An I/O controller 123 as shown in FIG. 1B may control the I/O devices. Furthermore, an I/O device may also provide storage and/or an installation device 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116 such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive; or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, a WiFi connection, a Bluetooth connection, a connection established according to the ZigBee specification, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, each of which may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L. P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc. of Cupertino, Calif. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea or HTC Headquarters of Taiwan, R.O.C. In other embodiments, the computing device 100 is a tablet device such as, for example and without limitation, the iPad line of devices manufactured by Apple Inc.; the PlayBook manufactured by Research In Motion; the Cruz line of devices manufactured by Velocity Micro, Inc. of Richmond, Va.; the Folio and Thrive line of devices manufactured by Toshiba America Information Systems, Inc. of Irvine, Calif.; the Galaxy line of devices manufactured by Samsung; the HP Slate line of devices manufactured by Hewlett-Packard; and the Streak line of devices manufactured by Dell, Inc. of Round Rock, Tex.

In some embodiments, an infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, an administrator of a machine 106a on a first network may use a remotely located data center to store servers 106b-n (including, for example, application servers, file servers, databases, and backup servers), routers, switches, and telecommunications equipment. The data center may be owned and managed by the administrator of the machine 106a on the first network, or a third-party service provider (including for example, a cloud services and hosting infrastructure provider) may provide access to a separate data center. Embodiments implementing such distributed infrastructure may be used to provide software as a service, and in some instances the distributed infrastructure allows for multi-tenant software as a service.

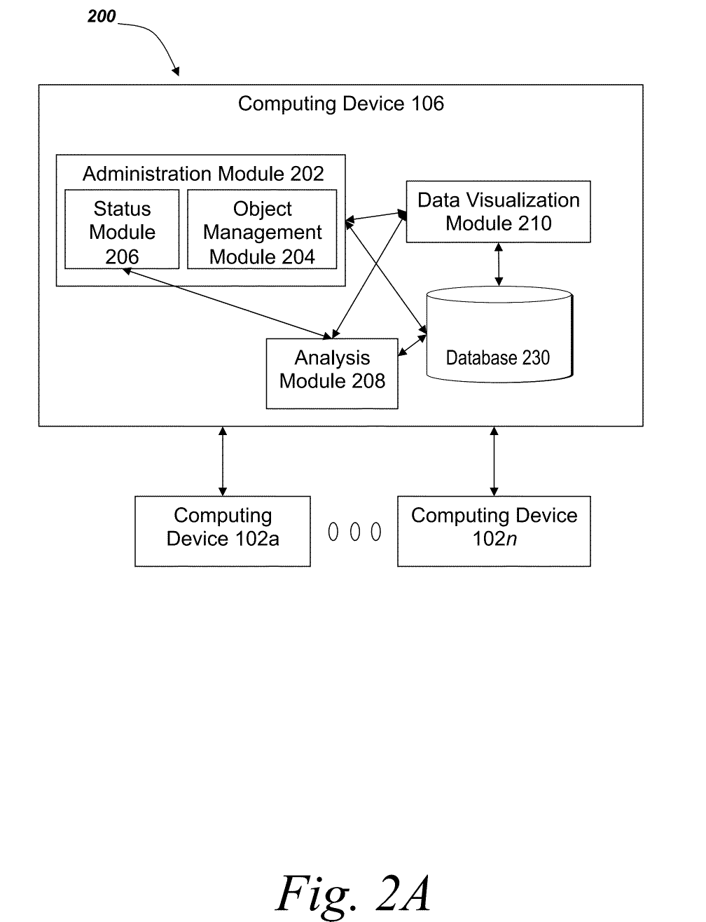

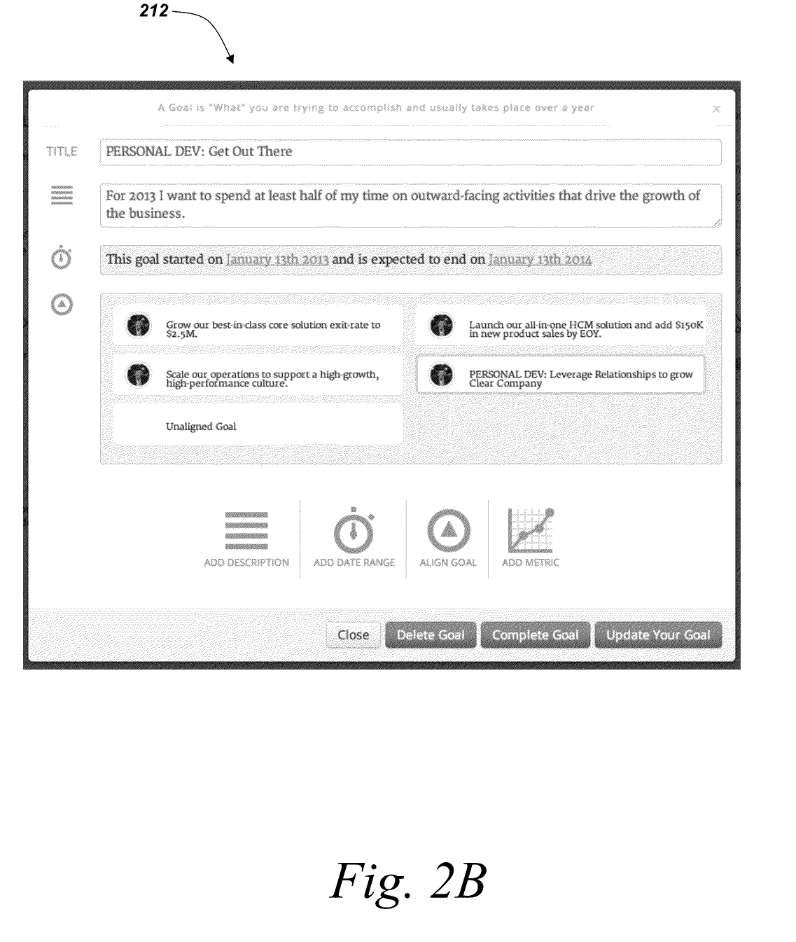

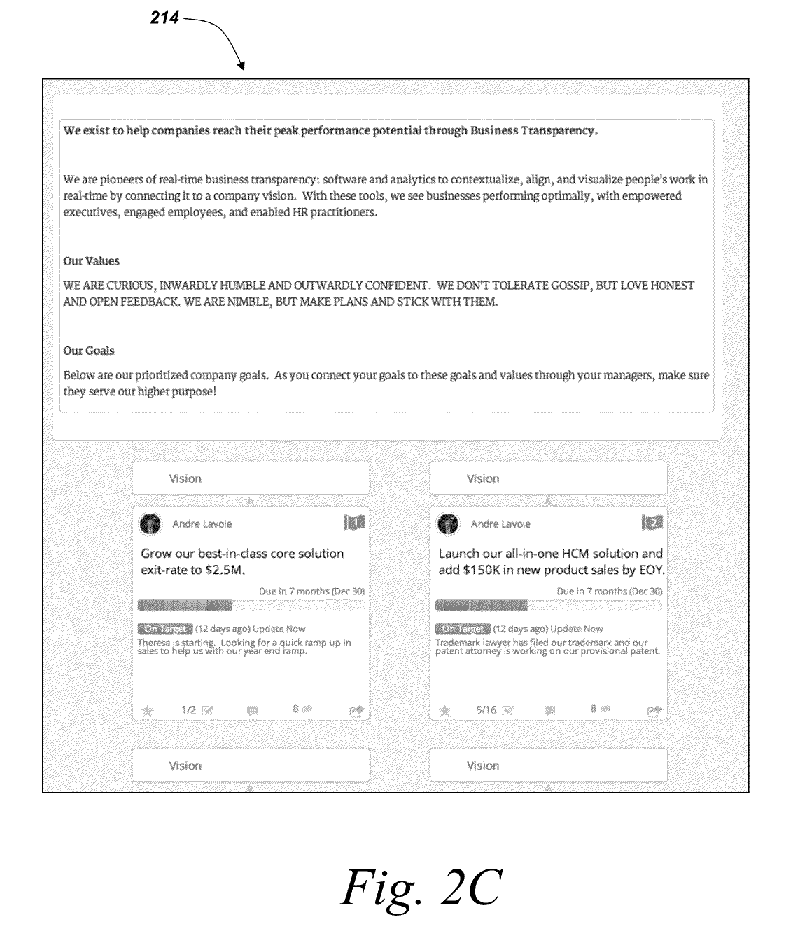

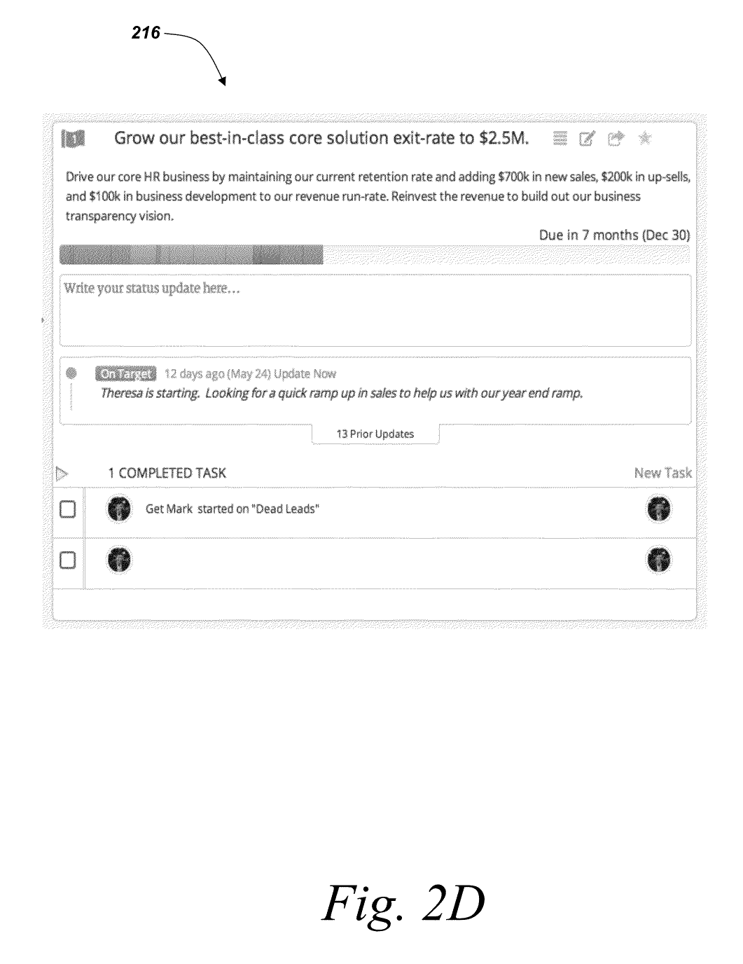

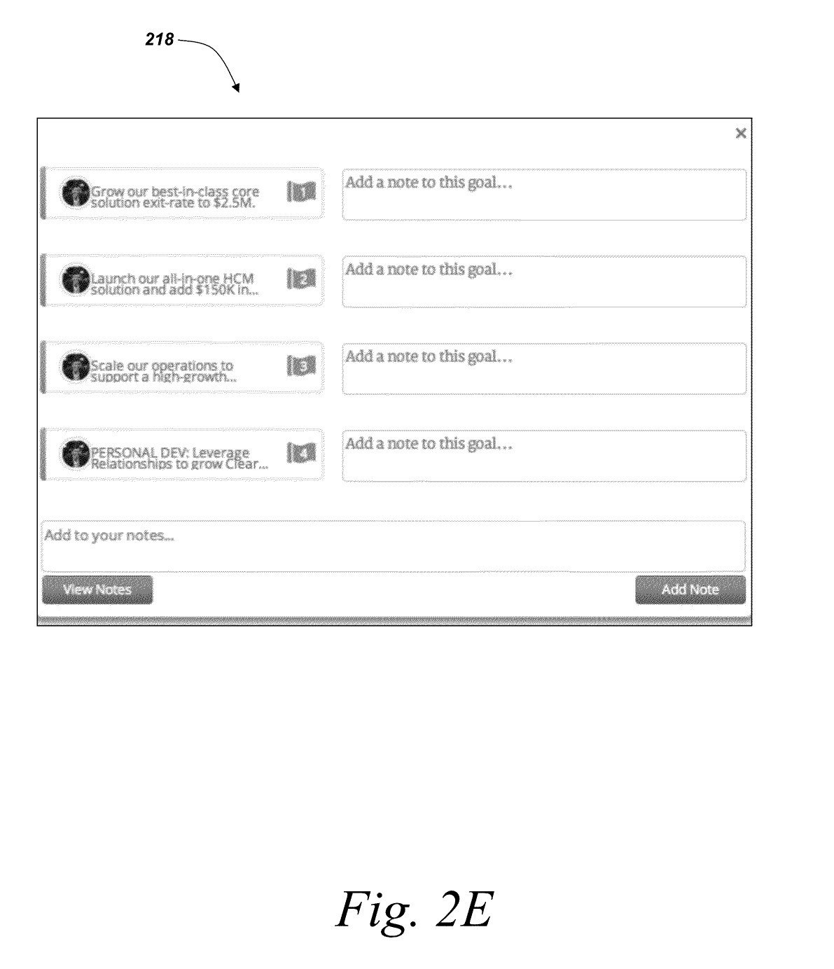

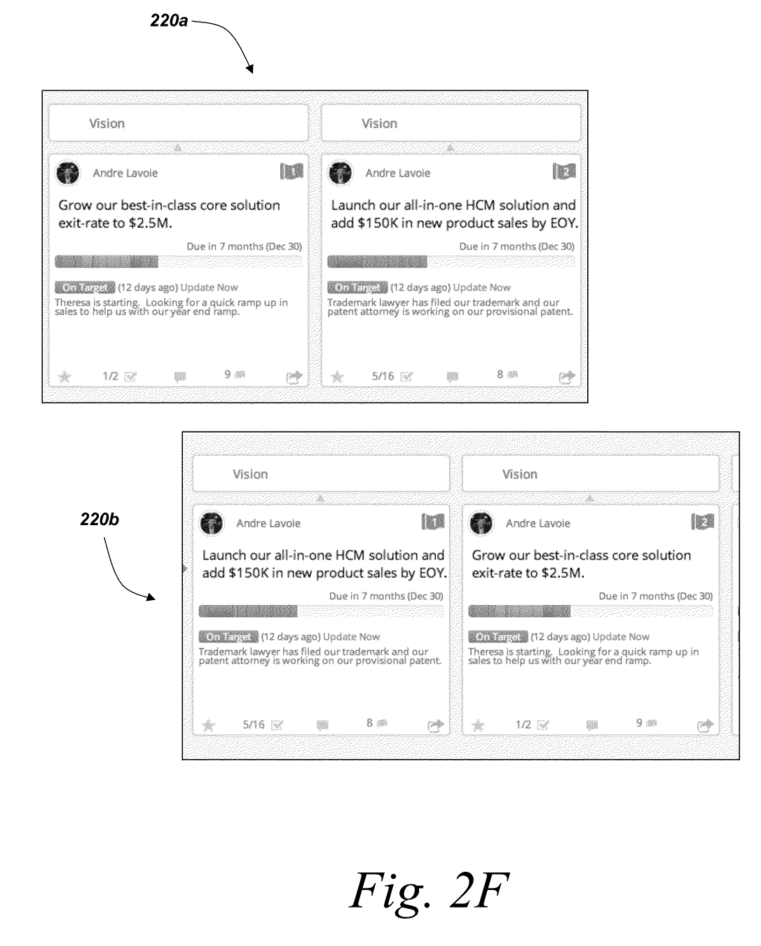

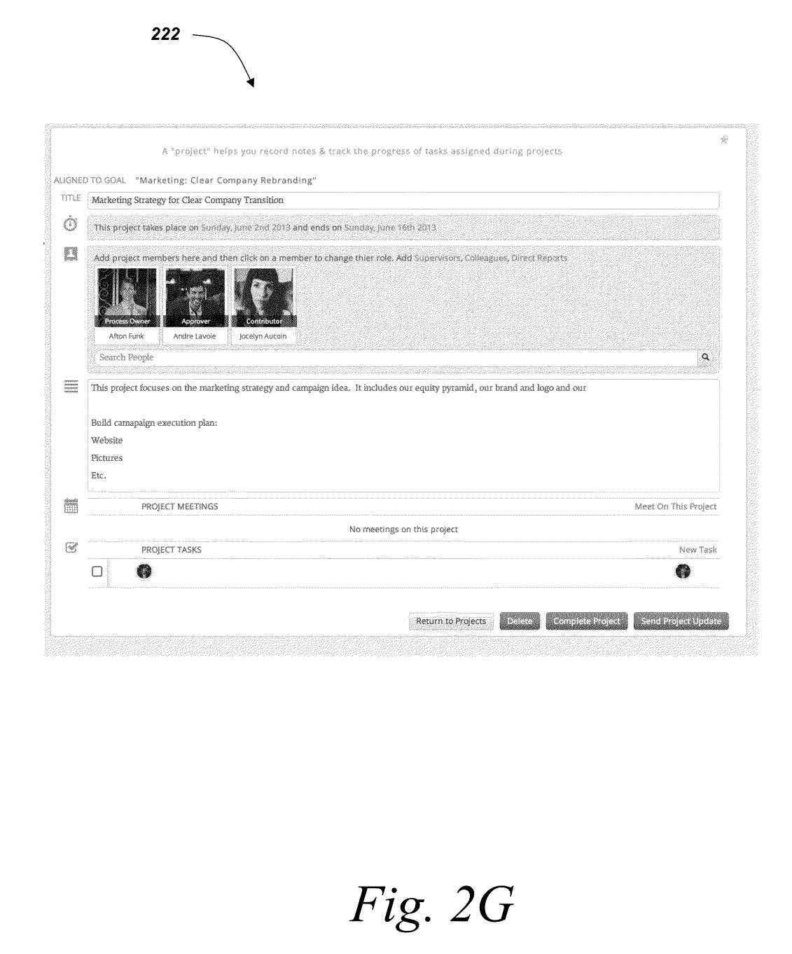

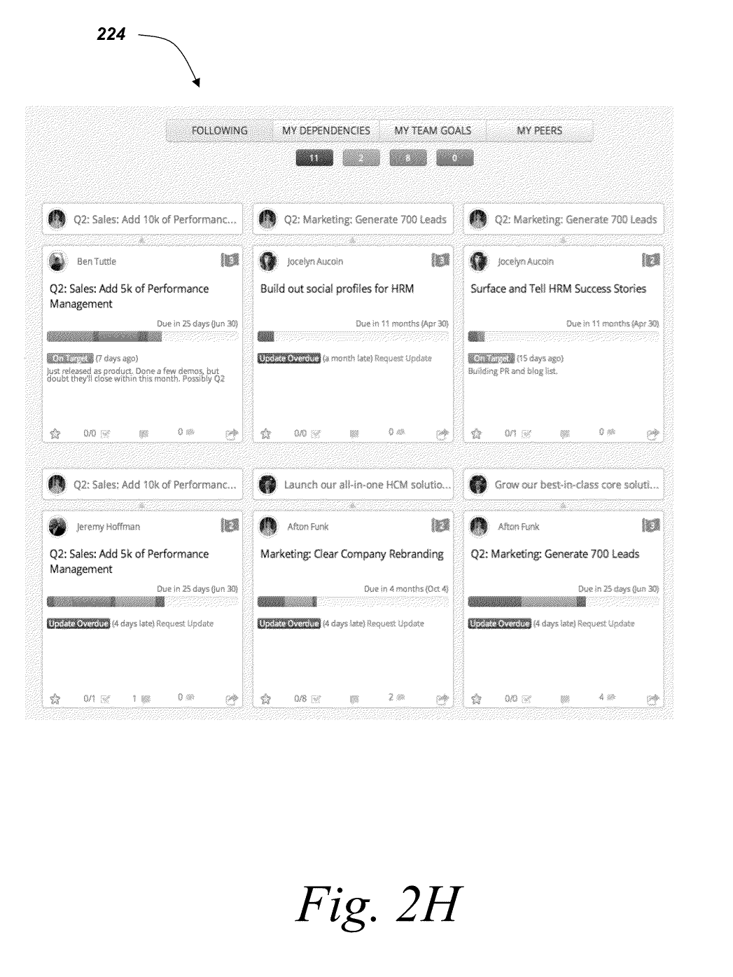

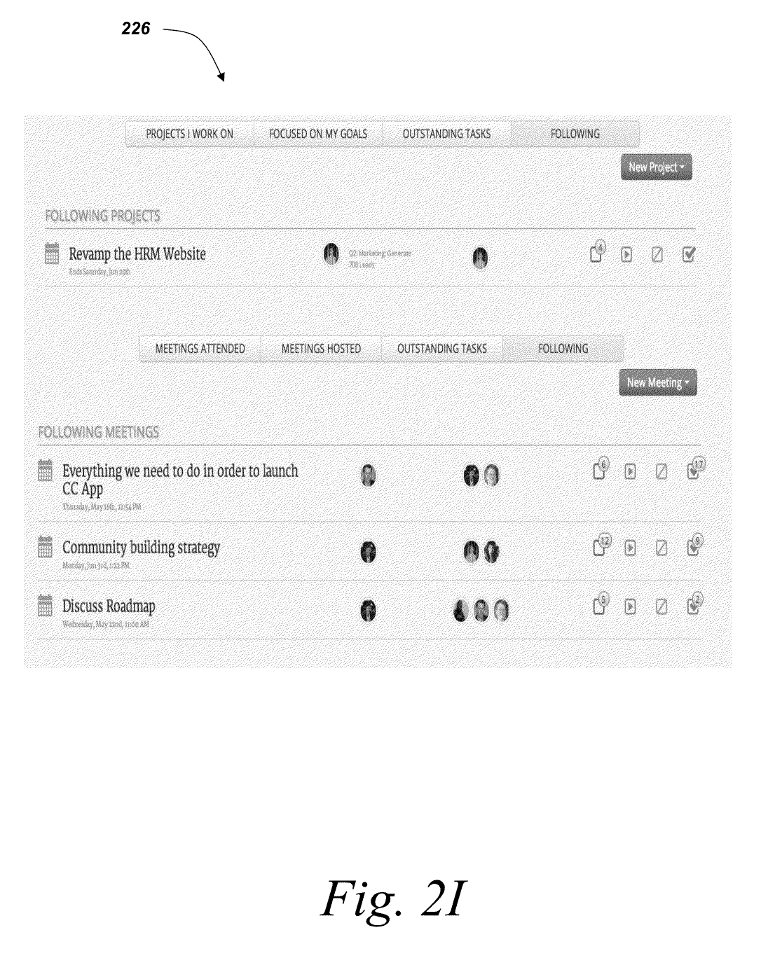

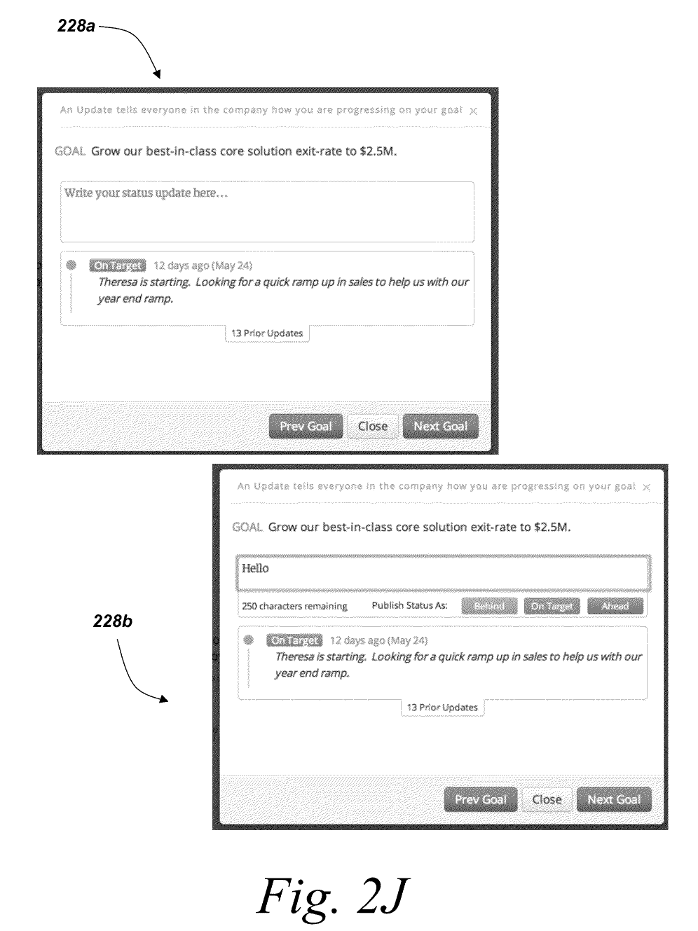

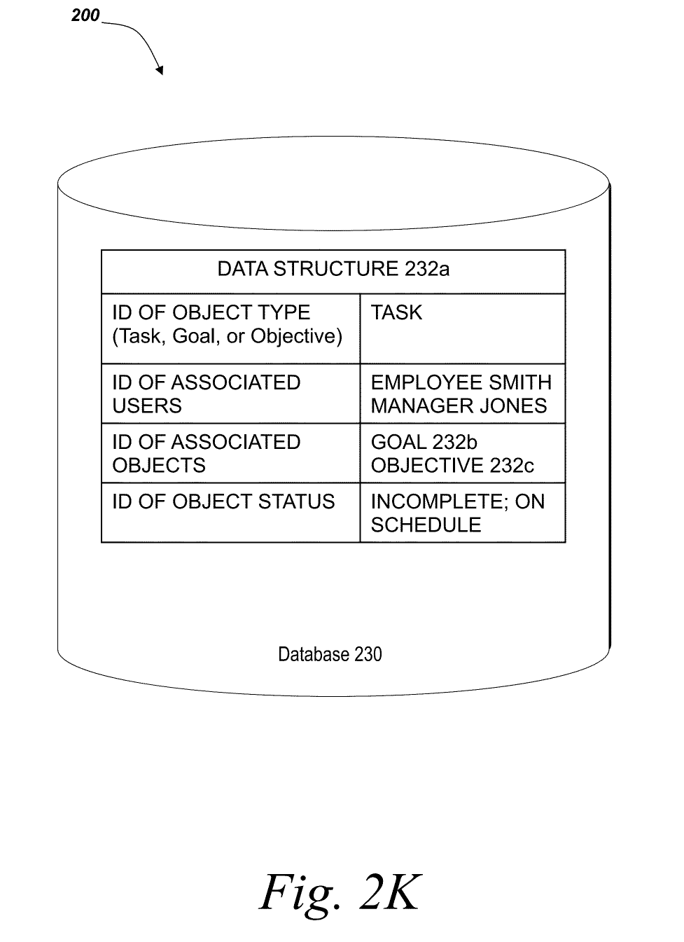

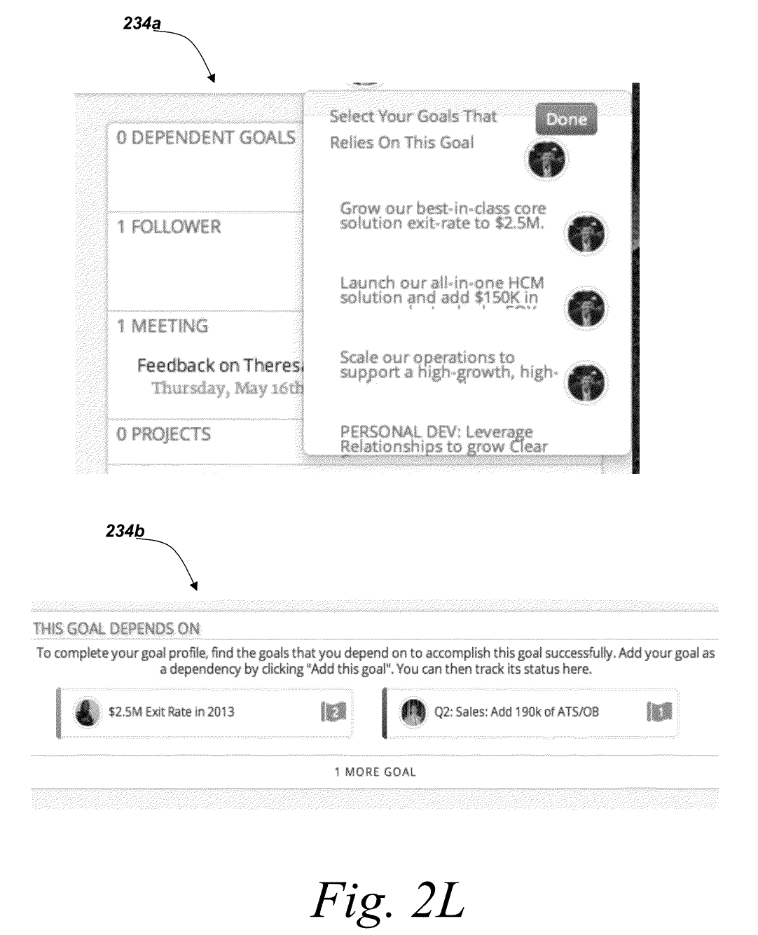

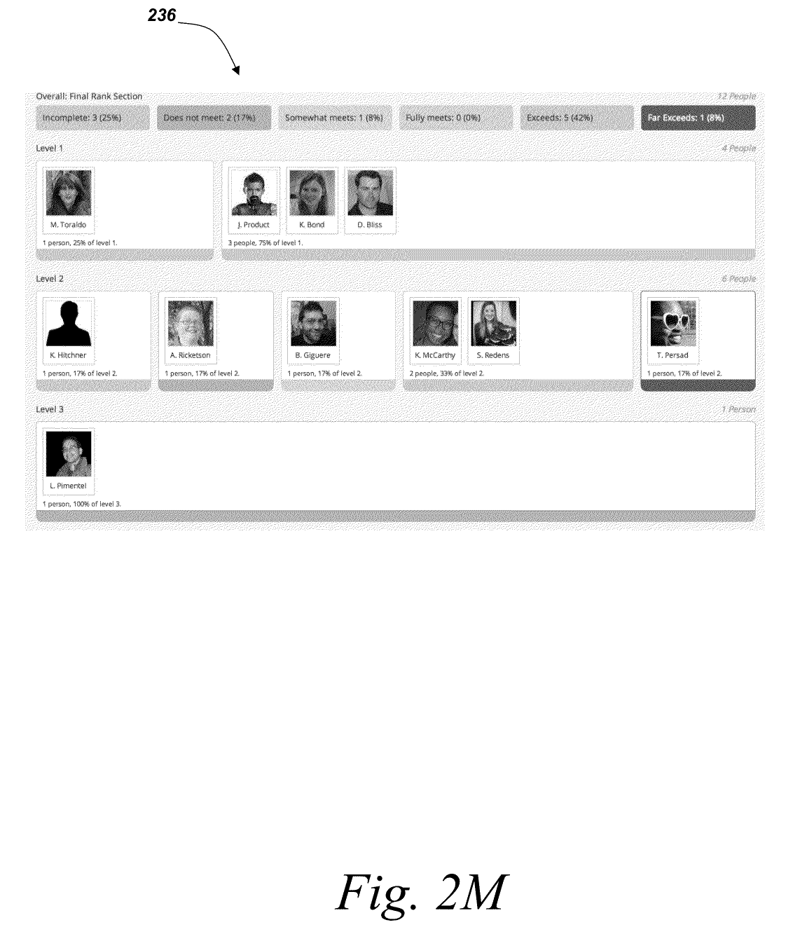

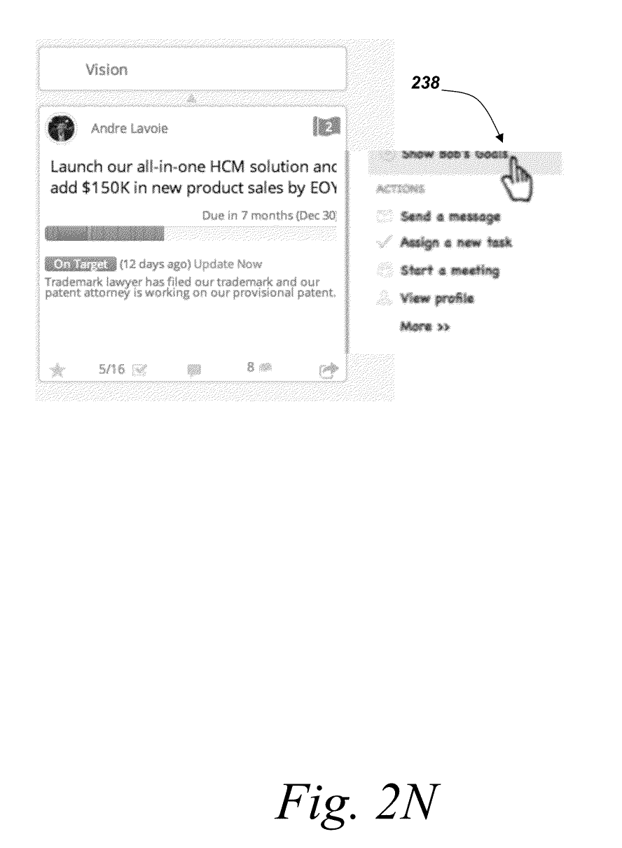

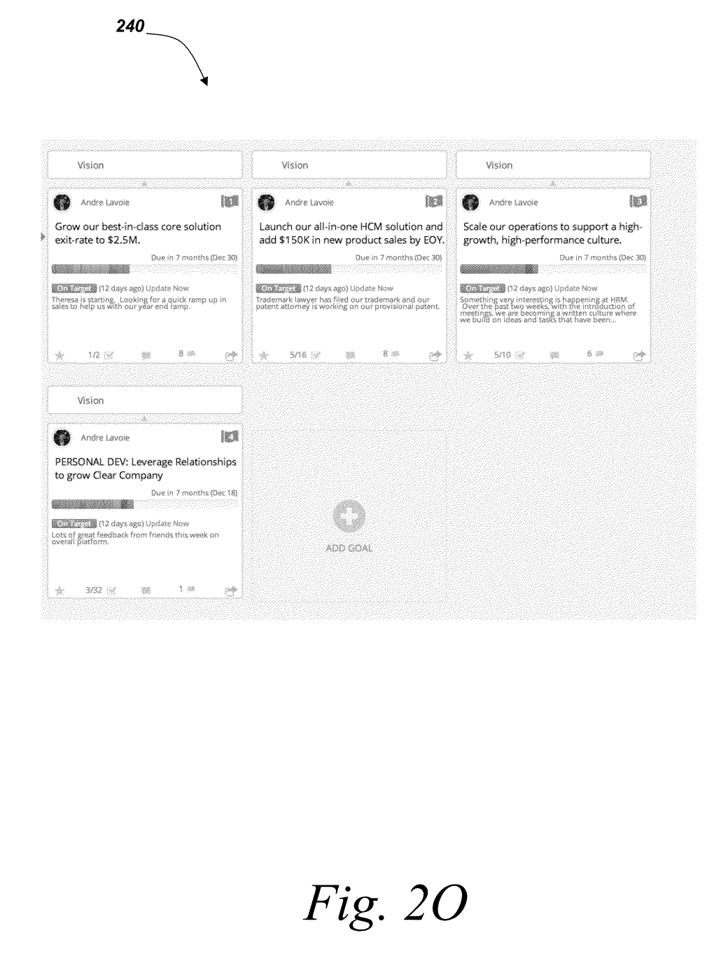

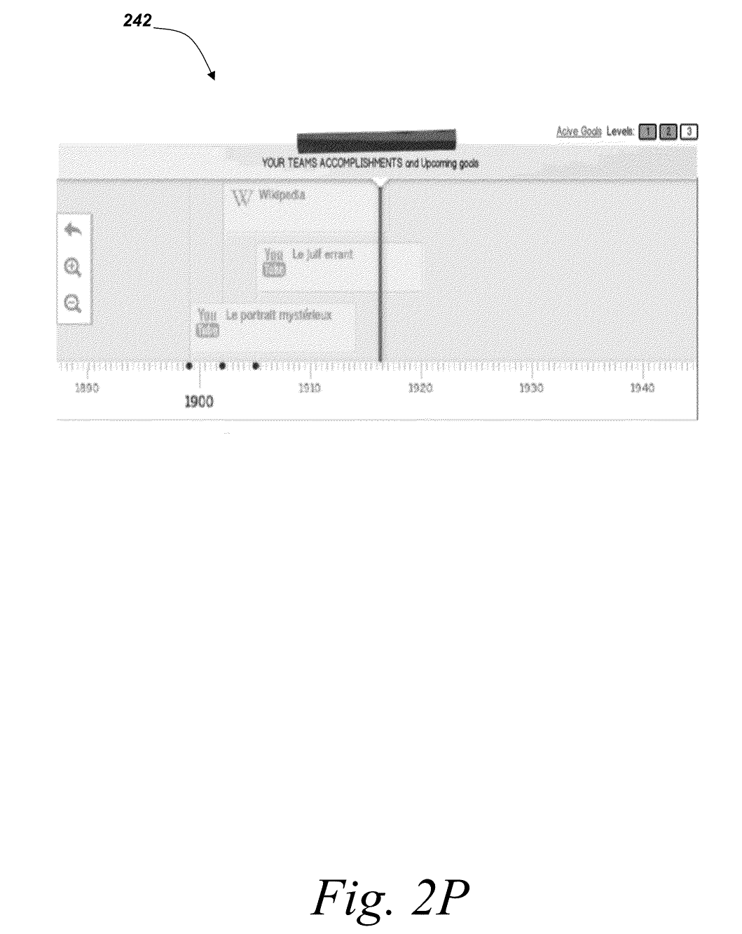

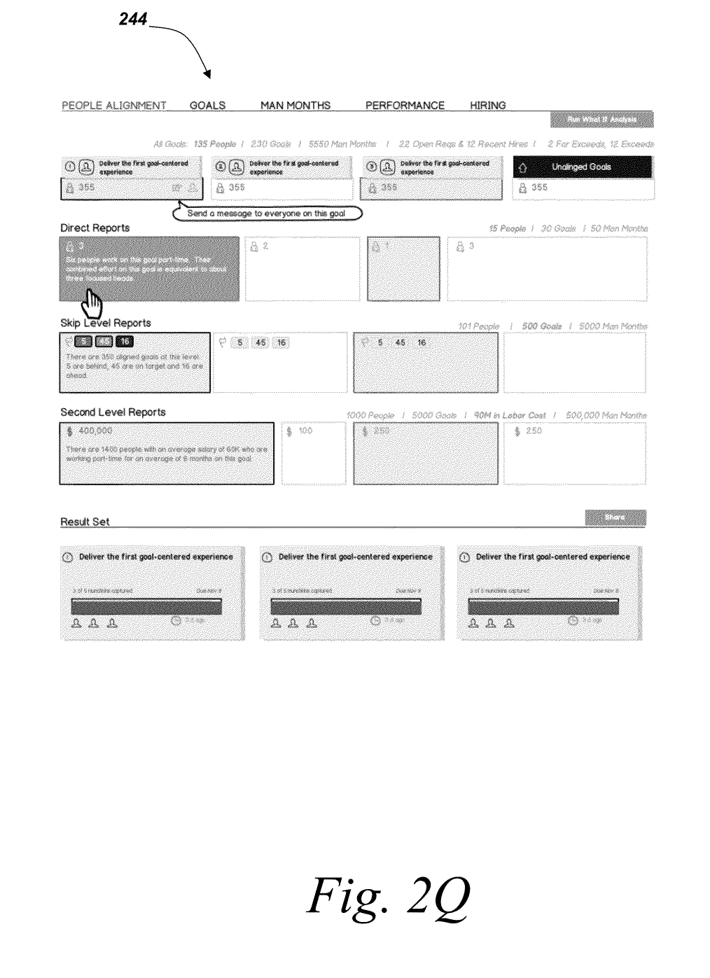

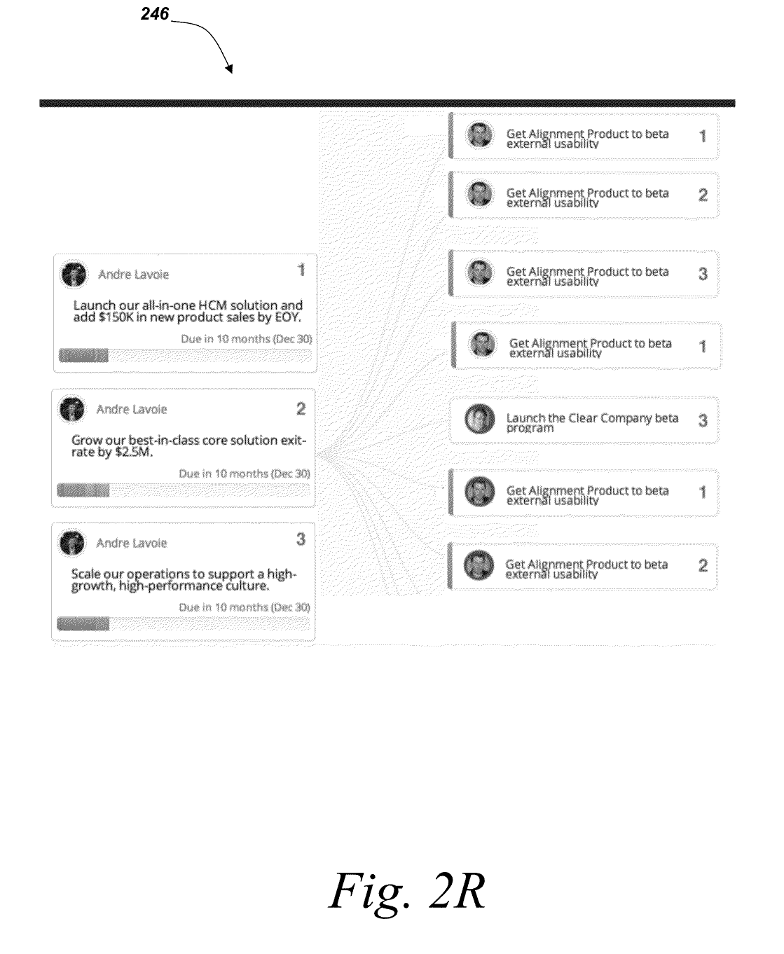

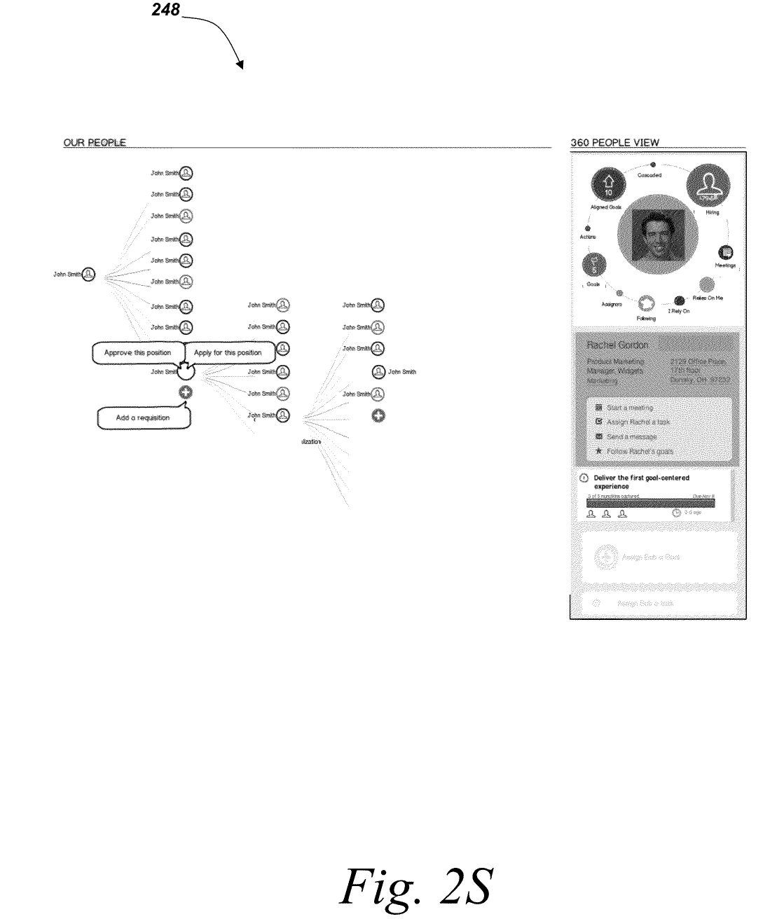

Referring now to FIG. 2A, a block diagram depicts one embodiment of a system 200 for real-time measurement of progress on employee tasks aligned to a corporate objective. In brief overview, the system 200 includes computing devices 102a-102n (referred to generally as computing devices 102) and a computing device 106. The computing device 106 executes an administration module 202, an object management module 204, a status module 206, an analysis module 208, a data visualization module 210, and a database 230.

Referring now to FIG. 2A, and in greater detail, the computing devices 102 and 106 may be provided as machines 100, as described above in reference to FIGS. 1A-1C. The computing device 106 may be a set of such machines 100 working together as a single unit. The computing device 106 may comprise a first machine 106a that executes software performing the methods set forth below, combined with a second machine 106b specializing in data storage. The computing devices 102 and 106 may communicate over a network 104 as described above in connection with FIGS. 1A-1C.

The system 200 includes the administration module 202, which may execute on the computing device 106. In one embodiment, the administration module 202 is provided as a software application. In another embodiment, the administration module 202 is provided as a hardware application. The administration module 202 may execute the object management module 204. The administration module 202 may execute the status module 206. The administration module 202 may be in communication with the analysis module 208. The administration module 202 may be in communication with the data visualization module 210.

The system 200 includes the object management module 204, which may execute on the computing device 106. In one embodiment, the object management module 204 is provided as a software application. In another embodiment, the object management module 204 is provided as a hardware application. The object management module 204 may provide interfaces with which users may create or modify an object. In one embodiment, the object represents a task. In another embodiment, the object represents a goal. In still another embodiment, the object represents a user, such as an employee. In another embodiment, the object represents a corporate objective, which may include objectives derived from, without limitation, mission statements, vision statements, strategic plans, and project plans. In yet another embodiment, the object represents a job description. The object management module 204 may store object-related data in the database 230. In some embodiments, a plurality of tasks with a common goal may be referred to as a “project.” The term “object,” as used herein, may refer to either tasks or goals or objectives.

Referring now to FIG. 2B, a block diagram depicts one embodiment of a user interface with which to create a goal. As depicted in FIG. 2B, the object management module 204 may provide a user interface 212 with which users may create or modify the goal. In some embodiments, the object management module 204 includes a receiver with which to receive requests for the creation or modification of tasks, goals, objectives, and other data objects for tracking by the system 200. For example, the object management module 204 may provide a user interface 212 with which a user (e.g., a user of the computing device 102) may request generation or modification of a task, a goal, or an objective. The object management module 204 may then create or modify data objects representing the task, goal, or objective. The user interface 212 may also be used to create tasks, corporate objectives, and other data objects.

Referring now to FIG. 2C, a block diagram depicts one embodiment of a user interface 214 with which to associate a goal with a corporate objective. The object management module 204 may provide the user interface 214 with which users may identify the corporate objective and specify the goal.

Referring now to FIG. 2D, a block diagram depicts one embodiment of a user interface 216 with which a user may associate a task with a goal. The object management module 204 may provide the user interface 216.

Referring now to FIG. 2E, a block diagram depicts one embodiment of a user interface 218 with which a user may associate data with data objects. In some embodiments, the user interface 218 is a receiver with which the object management module 204 may receive requests for association of data with tasks, goals, objectives, and other data objects. The object management module 204 may provide the user interface 218 with which a user may request association of data with a task, goal, or objective; for example, the user may request association of a file, a calendar event, a metric, an identification of another user, an identification of a status, associated dependencies, meetings, or projects, or other data objects with the task, goal, or objective.

In some embodiments, the object management module 204 associates objects with attributes. Attributes may include, without limitation, start dates, start times, estimated completion dates, date modifications, and actual completion dates. In other embodiments, the object management module 204 may associate multiple objects together. For example, and without limitation, the object management module 204 may associate a task with a goal, a calendar event with a task, a project with a goal, a user with a task, a first goal with a second goal, and a goal with a corporate objective both directly or transitively through a goal aligned through a management hierarchy to the corporate objective. As another example, the object management module 204 may associate a project, a task, and a note with a goal based on an alignment by users. As a further example, the object management module 204 may associate a task with a calendar event, such as a meeting where the task was assigned and aligned with a goal.

Referring now to FIG. 2F, a block diagram depicts one embodiment of a user interface 220 with which users may assign or modify levels of priority between objects. The object management module 204 may associate an object with a priority relative to other objects; for example, the object management module 204 may provide a user interface with which a user may provide instructions for the association of priorities by arranging visual representations of objects (e.g., by dragging and dropping the objects into a hierarchical structure). As depicted in FIG. 2F, the user interface 220a lists a goal of launching a product as a secondary goal (indicated by a number “2” in the upper right corner of the visual depiction of the goal) and allows a user to drag a visual representation of a first object (e.g., a goal) to a different position in a prioritized list of objects, resulting in the user interface 220b in which launching the product is listed as a primary goal (indicated by a number “1” in the upper right corner of the visual depiction of the goal).

Referring now to FIG. 2G, a block diagram depicts one embodiment of a user interface 222 for associating users with objects. As shown in FIG. 2G, a user may be associated with an object such as a project. The object management module 204 may associate objects representing users with objects representing tasks assigned to the users. The object management module 204 may provide the user interface 222 displaying users and associated objects.

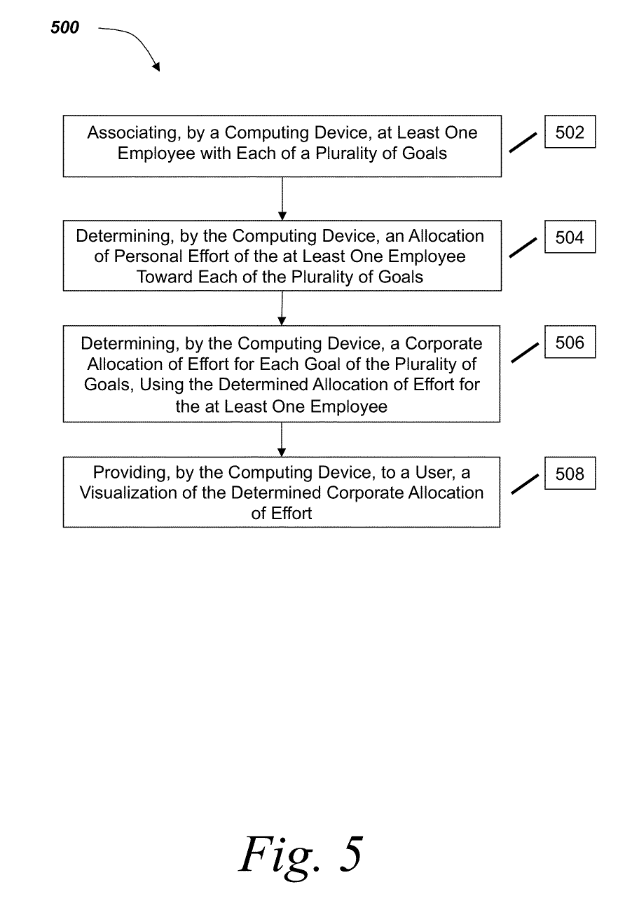

Referring now to FIGS. 2H and 21, block diagrams depict embodiments of user interfaces with which to monitor a level of progress of users associated with objects. As shown in FIG. 2H, the object management module 204 provides a user interface 224 with which a user may view a level of progress on one or more objects. In the example depicted in FIG. 2H, the objects are goals. The object management module 204 may make the user interface accessible to users assigned to the goals, as well as to any individuals interested in monitoring a level of progress of those users, who may be referred to as “followers” of the user or of the goal. As shown in FIG. 2I, the object management module 204 provides a user interface 226 with which a user may view a level of progress on a project. The object management module 204 may also associate objects representing tasks, goals, or objectives with, by way of example, comments, notes, related goals (e.g., dependency data identifying goals upon which the associated objects depends or cascading data identifying goals that were aligned to the associated objects), and ownership data. The system 200 may include functionality for generating suggestions for objects a user may wish to “follow.” The system 200 may also include functionality for generating suggestions for information a user may wish to include in a stream of information related to items of interest (e.g., a “feed”). These types of suggestions may be explicitly defined based on an association of objects, based on relationships established between objects (such as, without limitation, creation of a dependency, following a goal, or joining a project), or based indirectly on the relationships of the owners of those objects and their position in a corporate hierarchy (e.g., a manager has an interest in a goal or task associated with a report, or in a goal of her own manager or chief executive officer).

The system 200 includes the status module 206, which may execute on the computing device 106. In one embodiment, the status module 206 is provided as a software application. In another embodiment, the status module 206 is provided as a hardware application. In some embodiments, the status module 206 includes a receiver receiving an identification of a change to a status of a task, a goal, or an objective.

Referring now to FIG. 2J, a block diagram depicts one embodiment of a user interface 228 with which users may provide or modify a status of an object. FIG. 2J depicts the user interface 228a in which the user has not yet begun typing the status update and the user interface 228b in which the user has begun typing the status update (“Hello”). The status module 206 may provide the user interface 226 with which a user (e.g., a user of the computing device 102) may provide an instruction to modify a status of an object, such as a task, goal, or objective. The status module 206 may modify the status of the object based on the user instruction received via the user interface 228.

In one embodiment, a status update may include a qualitative representation of a status that indicates whether an individual associated with the object is on target, ahead, or behind on completion of the object. Qualitative representations may include colors or symbols indicating an overall status for the object. Qualitative representations may include notes about the overall status of the object. In some embodiments, a qualitative representation shows a status across multiple objects, such as a status of each of a plurality of tasks, goals, or objectives. In other embodiments, the qualitative representation represents the status of one or more users associated with one or more objects across groups of users; for example, by representing the statuses of users in an organizational chart, a cohort analysis, or a cascaded chart of goals. In further embodiments, a qualitative representation visually represents a histogram of a plurality of status updates over time with associated data. In such embodiments, the qualitative representation may also visually represent total estimated time for completion of a task, a goal, or an objective, as well as changes to the start and end dates and times.

In one embodiment, a status update includes a quantitative representation of a status. The quantitative representation may be a numerical value or other metric. The quantitative representation may be customizable by users to fit an organization's method for measurement. The quantitative representation may be rolled up to show the quantitative status across similar tasks, goals, objectives, groups, and organizations. The quantitative representation may include global metrics on which analyses may be performed. The quantitative representation may be visually represented, for example, as a time series or stacked bar. The quantitative representation may be user-modifiable. The status module 206 may provide functionality allowing users to integrate data from third-party systems to power the quantitative representation. The quantitative measure may cover both basic metrics, such as dollar value and percentage of goal, as well as calculated metrics, custom metrics and integrated metrics from other systems associated with goals, and derived metrics from other metrics both included in the system and imported from other systems.

In some embodiments, the status module 206 modifies a status of a task, a goal, or an objective, based upon receiving an identification of a change, while the data visualization module 210 generates visualizations of the modified data. In other embodiments, the status module 206 modifies a status of a task, a goal, or an objective, while the analysis module 208 identifies and updates associated data and the data visualization module 210 generates updated data visualizations.

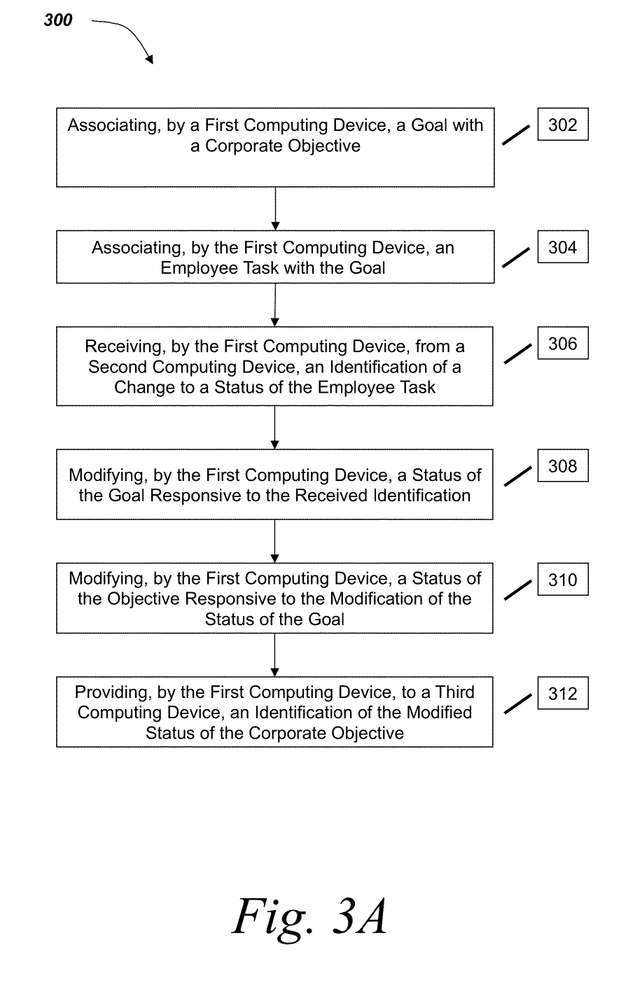

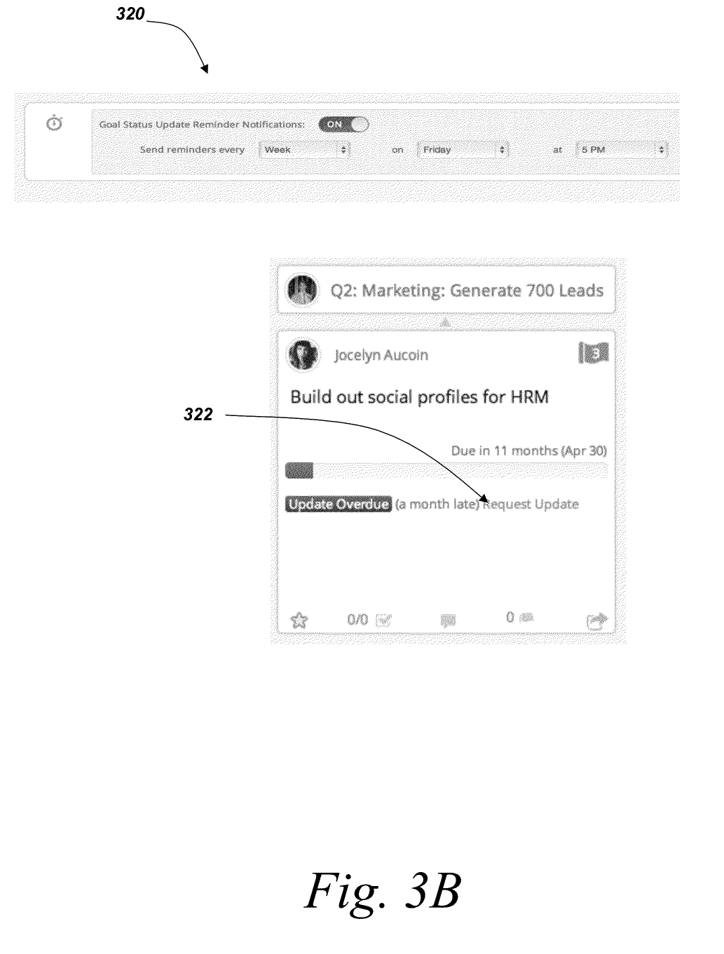

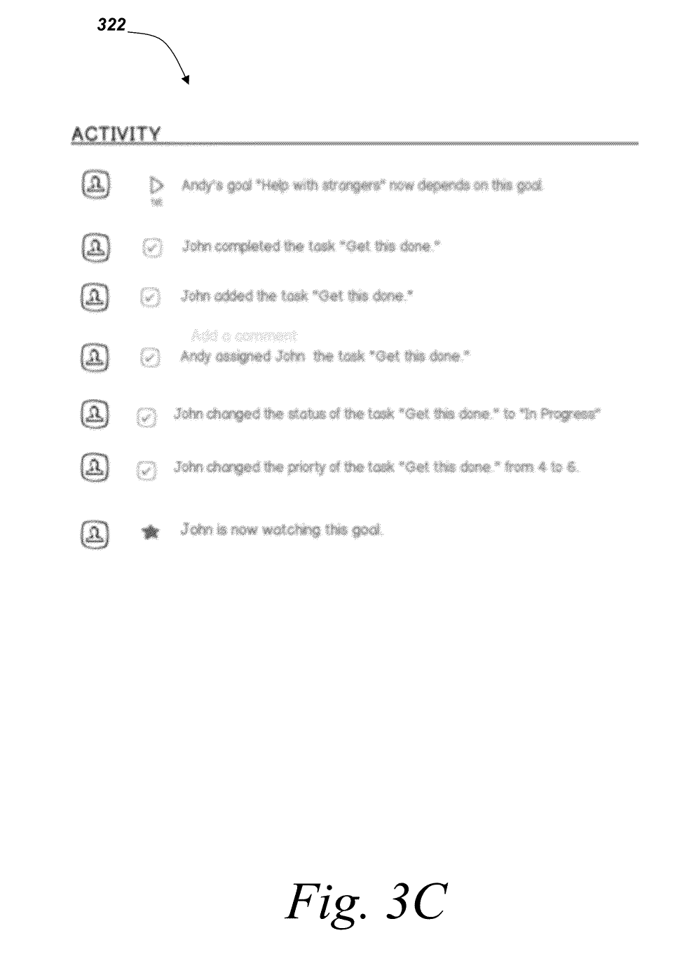

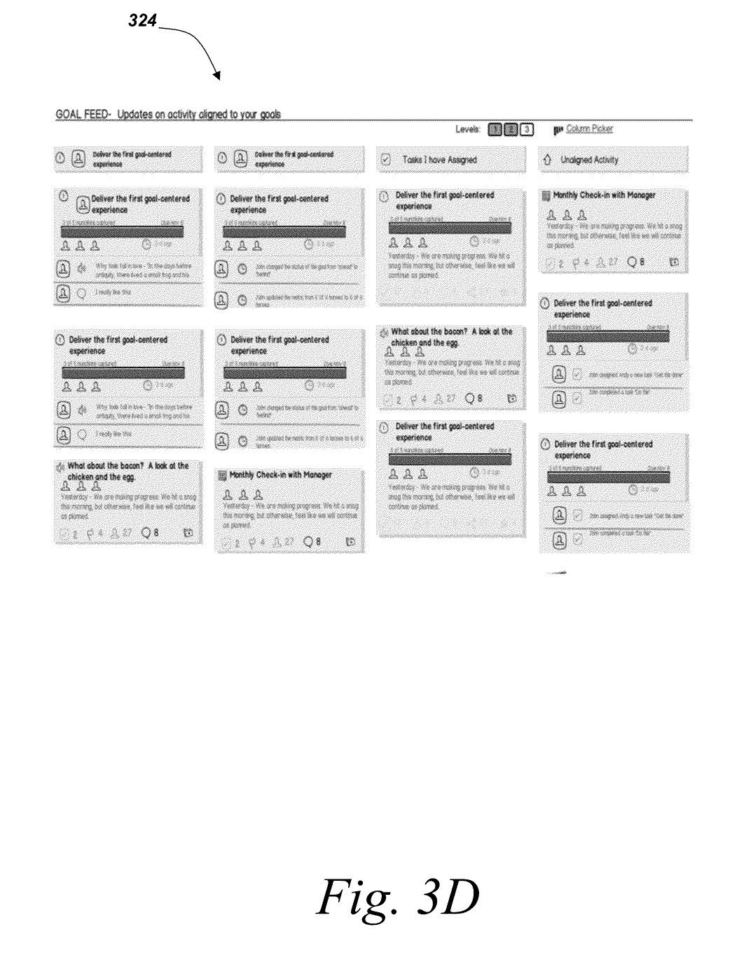

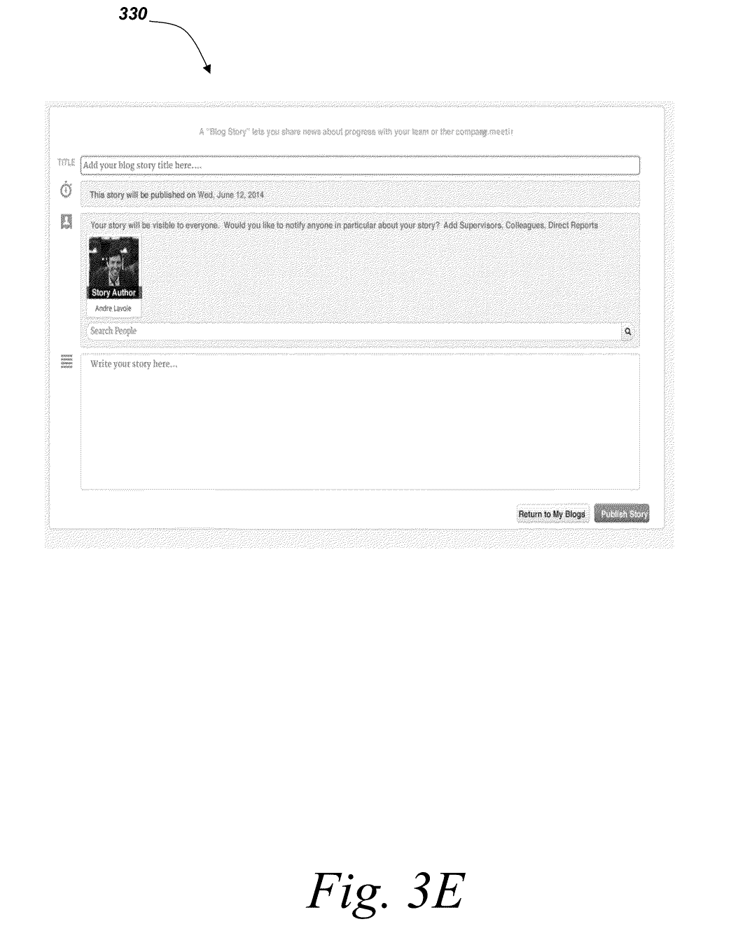

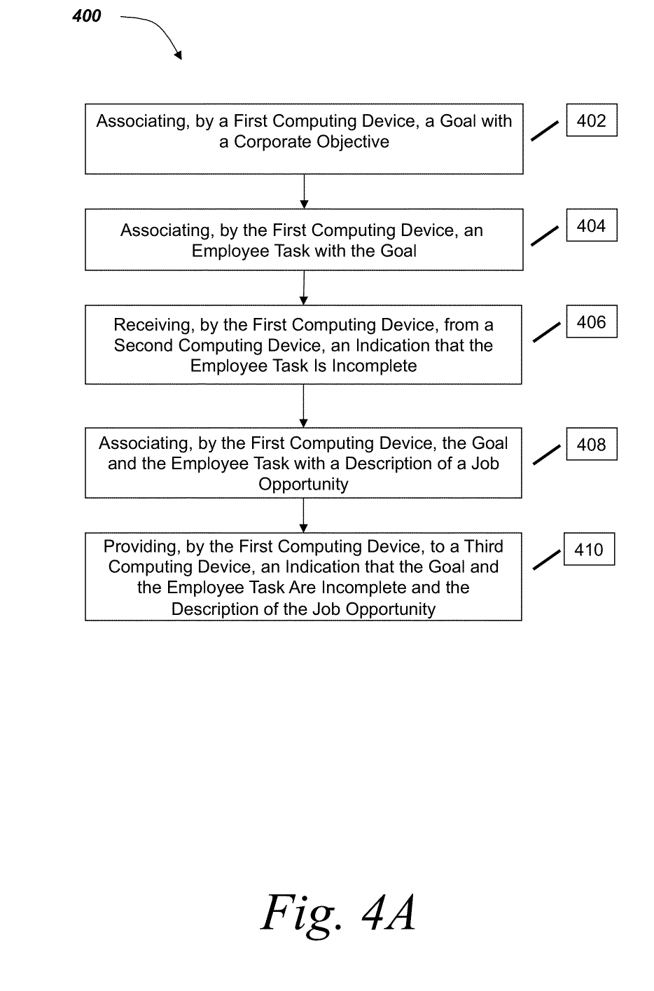

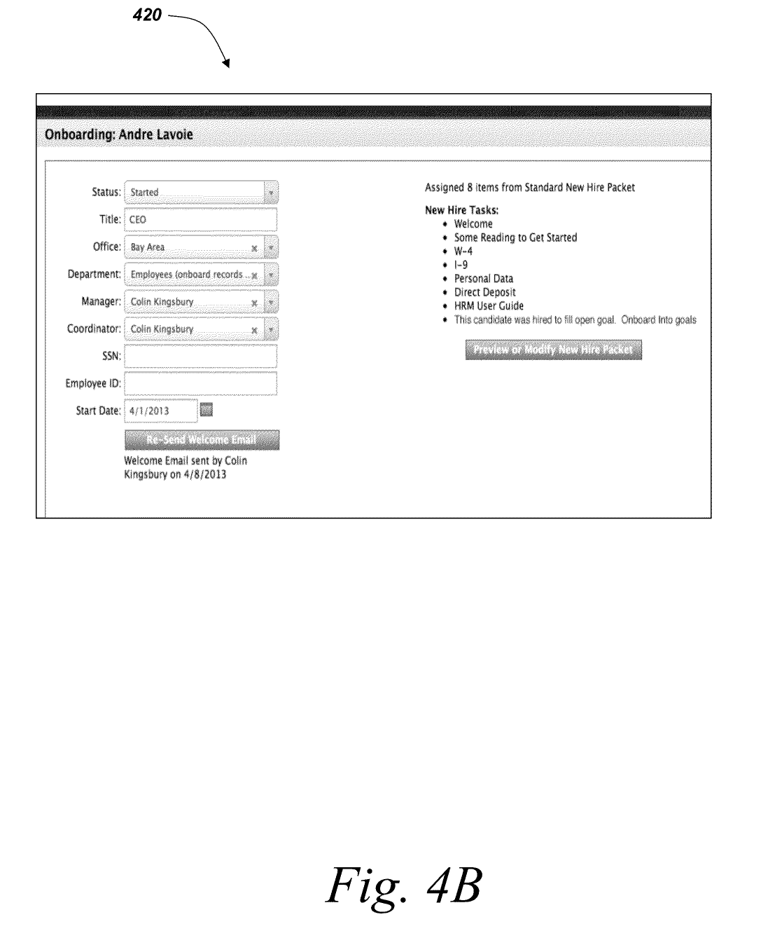

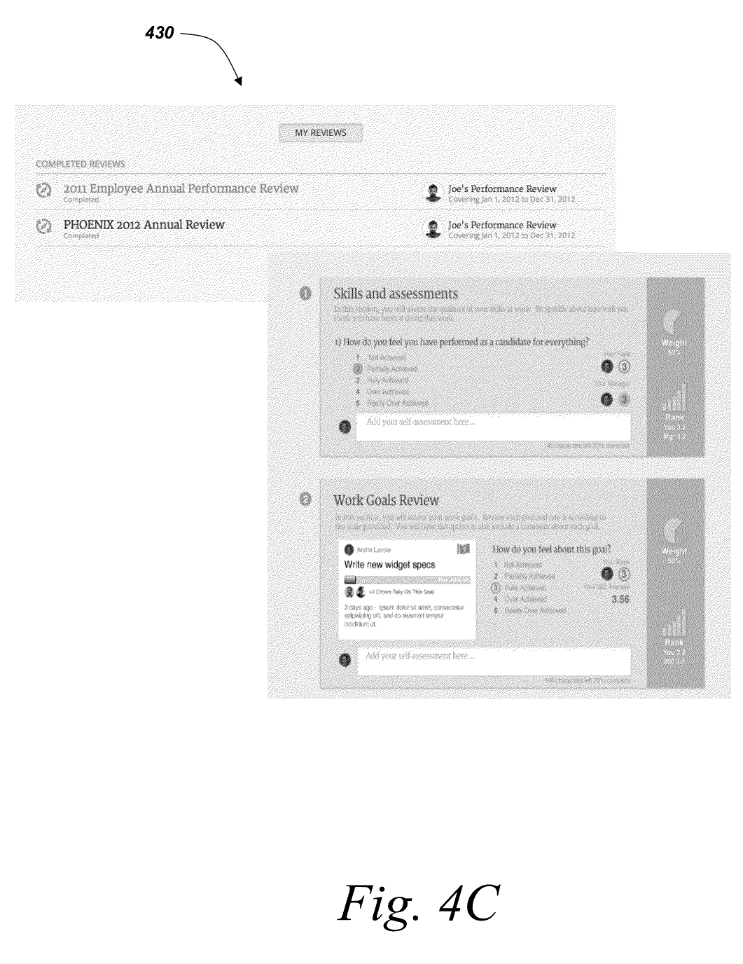

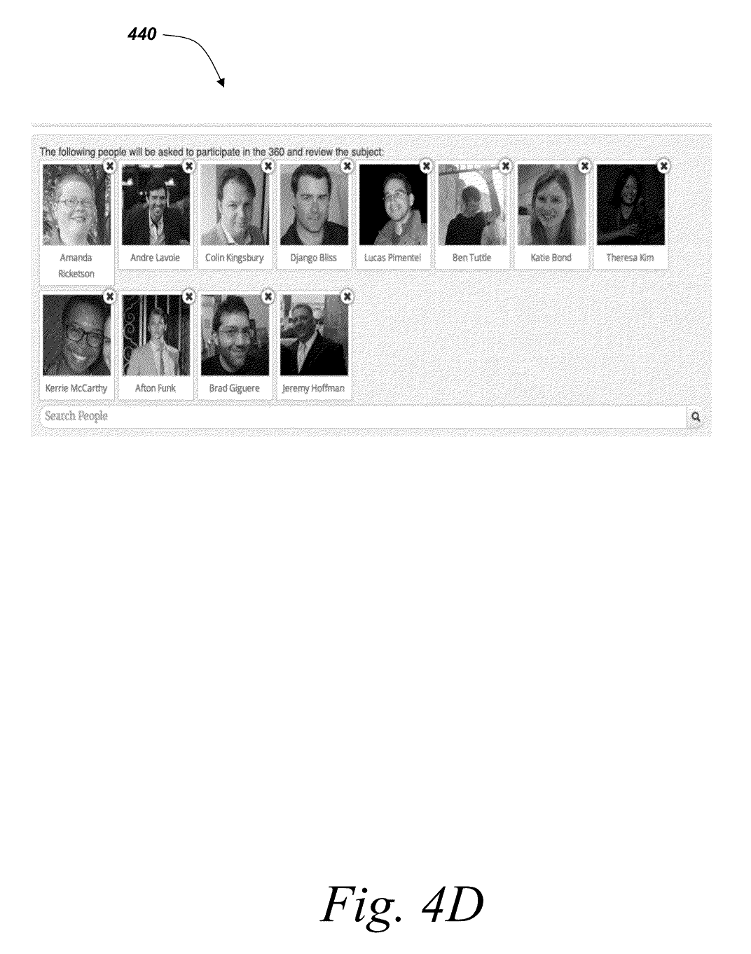

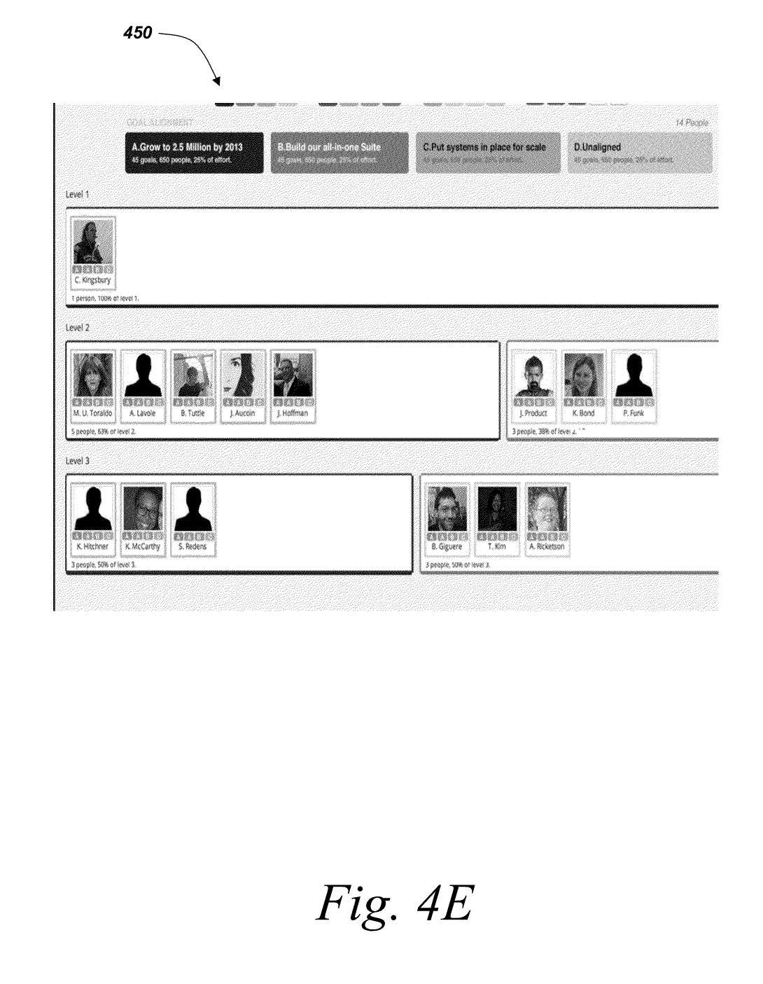

The system 200 includes the analysis module 208, which may execute on the computing device 106. In one embodiment, the analysis module 208 is provided as a software application. In another embodiment, the analysis module 208 is provided as a hardware application. In some embodiments, the analysis module 208 retrieves information from the database 230. In other embodiments, the analysis module 208 receives information from the administration module 202. The analysis module 208 may receive information explicitly provided by a user and generate additional information based on the received information. For example, the analysis module 208 may receive a notification from the status module 206 that a user has updated a status of a task, such as an employee task that the user has completed, and recalculate associated metrics (such as a percentage of completed tasks associated with that employee or associated with a division of a company associated with the employee). As another example, the analysis module 208 may identify associated objects (e.g., a corporate objective, such as an objective, mission or vision articulated in a company mission statement or otherwise specified by an employee, and associated with the employee task) and update information associated with the associated object. The analysis module 208 is discussed in greater detail in connection with FIGS. 3 and 4 below.

The system 200 includes the data visualization module 210, which may execute on the computing device 106. In one embodiment, the data visualization module 210 is provided as a software application. In another embodiment, the data visualization module 210 is provided as a hardware application. In some embodiments, the data visualization module 210 provides functionality for visually mapping relationships between tasks, goals, and objectives. In other embodiments, the data visualization module 210 provides functionality for ordering tasks, goals, and objectives. In still other embodiments, the data visualization module 210 provides functionality for sorting tasks, goals, and objectives. In further embodiments, the data visualization module 210 provides functionality for filtering tasks, goals, and objectives. In some embodiments, the data visualization module 210 provides functionality for prioritizing tasks, goals, and objectives. In other embodiments, the data visualization module 210 provides functionality for grouping tasks, goals, and objectives.

The data visualization module 210 may provide a user interface for viewing a graphical representation of tasks, goals, and objectives. The user interface may allow users to filter tasks, goals, and objectives; for example, users may choose to view goals owned or related to other goals through a corporate hierarchy, such as goals associated with a particular user (e.g., a manager) or set of users (e.g., peers at the same level or a division within a company). The user interface may also allow users to view, sort, or filter objects based on data associated with the objects or with users assigned to the tasks, goals, and objectives. For example, users may view, sort, or filter tasks, goals, and objectives based on, without limitation, any of the following: status, following, tag, priority, alignment, assignment, cascading, dependencies, organization structure (e.g., department, manager, division, or location), degrees of separation, keyword, shared projects, shared tasks, meetings, associated people, and timeline. In some embodiments, a user interface for viewing, sorting, or filtering tasks, goals, and objectives as described herein provides users with the ability to visualize, monitor, and model the execution of a company strategy in real time.

The data visualization module 210 may provide a user interface with which users may mathematically and visually analyze the aggregated results of the properties (owner, dependencies, alignment, status, projected completion dates) associated with goals through the use of, by way of example, organizational charts, cohort analyses, chord diagrams, indented tree visuals, maps and chloropleths, tree layouts, scatter plots, cartograms, and calendar views. In one embodiment, the data visualization module 210 shows aggregate quantitative numbers and qualitative colors representing overall performance of people in an organizational view or goals in a decomposed goal view. In another embodiment, the data visualization module 210 displays these views aggregated across organizational levels; the data visualization module 210 may provide an interface with which to select an aggregated section to view details of subordinate objects.

Although for ease of discussion the administration module 202, the object management module 204, the status module 206, the analysis module 208, and the data visualization module 210 are described as separate modules, it should be understood that this does not restrict the architecture to a particular implementation. For instance, a single circuit or software function may encompass these modules; as another example, the functionality of one or more components may be distributed across multiple components.

The system 200 includes the database 230. In one embodiment, the computing device 106 includes the database 230. In another embodiment, the computing device 106 is in communication with a second computing device 106b (not shown) that includes the database 230. In some embodiments, the database 230 is an ODBC-compliant database. For example, the database may be provided as an ORACLE database manufactured by Oracle Corporation of Redwood Shores, Calif. In other embodiments, the database can be a Microsoft ACCESS database or a Microsoft SQL server database manufactured by Microsoft Corporation of Redmond, Wash. In still other embodiments, the database may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md., MongoDB databases distributed by 10Gen, Inc. of New York, N.Y., and Cassandra databases distributed by The Apache Software Foundation. In further embodiments, the database may be any form or type of database.

Referring now to FIG. 2K, a block diagram depicts one embodiment of a data structure representing an object. The database 230 may store data structures representing one or more objects; for example, the database 230 may store a data structure representing a task, a goal, or an objective. As shown in FIG. 2K, the database 230 may store data structures 232a-232n (referred to generally as data structures 232). The data structure 232 may include an identification of a type of the object. The data structure 232 may include an identification of associated objects, such as an employee assigned to the task or a goal associated with the task. The database 230 may store a data structure including an identification of a status of the object, such as completed, incomplete and on track, incomplete and ahead of schedule, and incomplete and behind schedule.

Referring now to FIG. 2L, a block diagram depicts embodiments of a user interface for associating a goal with an object upon which completion of the goal depends. As shown in FIG. 2L, the user interface 234a provides functionality for selecting goals that rely upon a goal and the user interface 234b provides functionality for viewing goals upon which a selected goal depends.

Referring now to FIG. 2M, a block diagram depicts one embodiment of a user interface for viewing a plurality of objects. As shown in FIG. 2M, the user interface 236 allows a user to view one or more users associated with each of a plurality of objects (including goals, tasks, and projects), as well as viewing a status of each object. The user interface 236 may allow the user to view a hierarchical visualization of the plurality of objects.

Referring now to FIG. 2N, a block diagram depicts one embodiment of a user interface 238 for interacting with a user associated with an object. In one embodiment, the user interface 238 provides functionality for contacting a user associated with the object displayed, which is a goal in FIG. 2N. The functionality may include, without limitation, functionality for sending an electronic mail message, assigning a new task, starting a meeting, and viewing a profile.

Referring now to FIGS. 2O and 2P, block diagrams depict embodiments of user interfaces for viewing one or more goals. In one embodiment, and as shown in FIG. 2O, a user interface 240 allows a user to view at least one goal. In another embodiment, and as shown in FIG. 2P, a user interface 242 allows a user to view at least one goal along a timeline of accomplishments and upcoming goals.

Referring now to FIGS. 2Q-2S, block diagrams depict various embodiments of user interfaces for viewing alignment of objects throughout an organization.

In some embodiments, the methods and systems described herein provide functionality enabling a social goal grid that provides transparency into the execution of a strategy within an organization. In other embodiments, the system 200 leverages a corporate hierarchy as a means of entitlement allowing users to hierarchically prioritize or edit goals and tasks beneath them. In still other embodiments, the system 200 leverages the corporate hierarchy allowing users to add cascading goal metrics that can be completed by subordinates. In further embodiments, the system 200 leverages the corporate hierarchy allowing users to aggregate indicators of progress on tasks, goals and dependencies up levels in the hierarchy based on alignment.

In one embodiment, the system 200 allows users involved in developing or managing corporate strategy or missions to create and self-map the relationships of their own goals and the goals they are entitled to edit independently of each other; this may result in a crowd-sourced mapping of alignment, dependencies, project participation, meeting alignment, task alignment, and project alignment. The system 200 may also allow users to explicitly avoid aligning a task, project, or goal, providing functionality for identifying unaligned effort. In another embodiment, the system 200 provides functionality for, without limitation:
attributing performance of people in the organization and the goals they work on to the overall performance of the company;
measuring alignment and alignment drift and their impact on organizational performance;
measuring business transparency;
forecasting goal completion dates;
improving organizational design (simplification and optimization); and
measuring goal effort.

Referring now to FIG. 3A, a flow diagram depicts one embodiment of a method for real-time measurement of progress on employee tasks aligned to a corporate objective. The method 300 includes associating, by a first computing device, a goal with a corporate objective (302). The method 300 includes associating, by the first computing device, an employee task with the goal (304). The method 300 includes receiving, by the first computing device, from a second computing device, an identification of a change to a status of the employee task (306). The method 300 includes modifying, by the first computing device, a status of the goal responsive to the received identification (308). The method 300 includes modifying, by the first computing device, a status of the objective responsive to the modification of the status of the goal (310). The method 300 includes providing, by the first computing device, to a third computing device, an identification of the modified status of the corporate objective (312).

In some embodiments, the computing device 106 receives an identification of a company mission statement from a user. A company mission statement typically includes one or more aspirational objectives describing why the company exists. The methods and systems described herein provide users with functionality for tracking progress towards such aspirational objectives by associating the objectives with more specific goals and even more specific, actionable tasks. While an aspirational objective within a company mission statement may express why the company exists, a goal may broadly indicate what the company should accomplish in order to live up to its reason for existing, and a task may specify what actions one or more members of the company need to execute in order to meet the goal. For example, a mission statement may include an objective indicating that a company exists to pioneer new software; for such a company, one goal may be to launch the software and add $150,000 in new product sales; associated tasks may include launching a beta version of the software, scheduling a meeting to discuss the final revisions to the beta version of the software, and preparing marketing materials promoting the launch. Therefore, methods and systems described herein provide the user with an interface for defining increasingly specific objects for use in tracking company-wide progress towards implementation of the objectives specified in the company mission statement. In some embodiments, implementation of such methods and systems provides, to employees at all levels of an organization, increased transparency as to a level of progress and an understanding of what specific tasks prevent or promote completion of goals and alignment to organizational objectives.

Referring now to FIG. 3A, in greater detail and in connection with FIGS. 2A-S, the method 300 includes associating, by a first computing device, a goal with a corporate objective (302). In one embodiment, the object management module 204 receives an identification of the objective. In another embodiment, the object management module 204 receives an instruction by a user to associate the goal with the objective. For example, a supervisor may access a user interface provided by the object management module 204 to instruct the computing device 106 to associate the goal with the objective. In still another embodiment, the object management module 204 creates a new data structure 232a for the objective, if one does not already exist. In another embodiment, the object management module 204 creates a new data structure 232b for the goal, if one does not already exist. In still another embodiment, the object management module 204 adds an identification of the association to the data structure 232a. In yet another embodiment, the object management module 204 adds an identification of the association to the data structure 232b.

The method 300 includes associating, by the first computing device, an employee task with the goal (304). In one embodiment, the computing device 106 receives an instruction to associate the employee task with the goal from a user. For example, a supervisor may access a user interface provided by the object management module 204 to instruct the computing device 106 to associate an employee with the employee task and the employee task with the goal. In another embodiment, the object management module 204 creates a new data structure 232c for the employee task, if one does not already exist. In still another embodiment, the object management module 204 adds an identification of the association to the data structure 232b. In another embodiment, the object management module 204 adds an identification of the association to the data structure 232c. In yet another embodiment, the object management module 204 adds an identification of the association to the data structure 232a. In some embodiments, the object management module 204 associates a meeting with the goal instead of, or in addition to, an employee task. In such embodiments, users associated with (e.g., invited to) the meeting may associate additional objects, such as new employee tasks, with the meeting (and therefore, indirectly, with the goal). Such users may, for example, hold a meeting, assign tasks in the meeting, and then later, after the meeting has ended, view the meeting object data to identify what goal(s) the meeting was aligned with, what employee tasks were assigned, and what the status is for each of those employee tasks.

The method 300 includes receiving, by the first computing device, from a second computing device, an identification of a change to a status of the employee task (306). In one embodiment, the status module 206 receives the identification of the change to the status of the employee task.

Referring ahead to FIG. 3B, a block diagram depicts embodiments of user interfaces with which users may instruct the computing device 106 to request periodic status updates. In one embodiment, a user may instruct the computing device 106 to request periodic status updates using an interface 320. In another embodiment, the user may identify an object for which no status updates have been received for a threshold period of time and instruct the computing device 106 to request a one-time status update, in addition to or instead of any other scheduled requests. In some embodiments, the computing device 106 transmits, to the computing device 102, a request for the identification of the change to the status of the employee task. In one of these embodiments, the status module 206 transmits a reminder to the second computing device that the employee has not updated the status of the employee task in a particular period of time. For example, a project manager may send an instruction to the status module 206 indicating that employees associated with tasks required for completion of a project that the project manager oversees should update their tasks within a particular period (e.g., daily, weekly, and monthly); the status module 206 can modify a data structure 232c for a particular task to indicate whether the associated employee has updated the status within the requested period. In other embodiments, the status module 206 transmits a notification to an employee indicating that the employee has been assigned to a new employee task. In one of these embodiments, for example, a project manager or other supervisor may assign an employee to a new employee task by associating the employee with the employee task when creating the employee task in the object management module 204. In another of these embodiments, and as another example, an employee may be assigned to an employee task during a meeting in which the employee volunteered for or was assigned to the task.

In other embodiments, the status module 206 transmits a notification to a supervisor associated with an employee task that the employee has modified the status of the task. For example, the status module 206 may transmit the notification to the supervisor indicating that the employee has completed a part of or the entire task or delegated a part of or the entire task to another employee. As another example, the status module 206 may transmit a notification to a first employee that a second employee has modified a status of a first task on which a second task associated with the first employee depends. As a further example, users may subscribe for notifications of modifications to objects including, without limitation, meeting data; summaries of notes and tasks associated with meetings; comments associated with meetings; updates to meeting data, project data, project updates, project deletions, project completions, metric additions, metric deletions, metric changes, project comments, new project members, project role changes, blog data, post date, comment data, performance review data, performance review due date, performance review requests, task data, task completion, task changes, task date changes, and task comments. It should be understood that notifications may be provided using any number of methods of communication including, but not limited to, electronic mail messages, alerts sent via short message service, alerts displayed on a computing device 102 (which may be, for example, desktop computing devices or mobile computing devices), and messages displayed in online interfaces.

Referring now to FIGS. 3C-3D, block diagrams depict embodiments of a user interface for viewing one or more notifications. As shown in FIG. 3C, notifications may be provided as a stream of data referred to as an “activity feed.” As shown in FIG. 3D, the system may display an activity feed by listing depictions of each goal in the feed.

In some embodiments, users receive notifications relating to actions taken to objects associated with them (e.g., their own data; their tasks, projects, or goals; their messages). In other embodiments, users receive notifications relating to objects they have subscribed to or are otherwise following.

Referring back to FIG. 3A, the method 300 includes modifying, by the first computing device, a status of the goal responsive to the received identification (308). In one embodiment, the status module 206 makes the modification. In another embodiment, the analysis module 208 receives a notification that the status module 206 has modified the status of the employee task and the analysis module 208 accesses the data structure 232c of the employee task to identify the associated data structure 232b for the goal and makes the modification to the status of the goal.

The method 300 includes modifying, by the first computing device, a status of the objective responsive to the modification of the status of the goal (310). In one embodiment, the status module 206 makes the modification. In another embodiment, the analysis module 208 receives a notification that the status module 206 has modified the status of the employee task and the analysis module 208 accesses the data structure 232c of the employee task to identify the associated data structure 232a for the goal and makes the modification to the status of the goal.

In some embodiments, users within a first organization may invite users unaffiliated with the first organization to view objects. For example, a user within the first organization may invite a user within a second organization (e.g., a contractor, a partner, and a service provider) to view objects such as meetings, goals, tasks, projects, or stories with a limited view of the entire application.

In some embodiments, the methods and systems described herein provide functionality for modeling goal-based metrics as semantically-descriptive data; defining classes and subclasses of metrics with inheritance similar to object-oriented programming languages enables analysis of that data. Data can be used in multiple contexts without having to redefine the meaning of the metric specific to each context or altering the source data. In addition, data may be natively stored as a time series as opposed to only storing the current value with historical values archived separately in a manner that makes time-based analysis difficult or impossible.

In some embodiments, the method includes analyzing a level of progress towards completion of the employee task. For example, the analysis module 208 may receive a notification that the status module 206 has modified the status of the employee task and the analysis module 208 may determine, based on the notification, the level of progress towards completion of the employee task. In other embodiments, the analysis module 208 may analyze a level of progress towards completion of a goal based upon the analysis of the level of progress towards completion of the employee task. In further embodiments, the analysis module 208 may determine a value representing a level of progress based upon the received identification of the change to the status of the employee task.

In some embodiments, the object management module 204 associates a file with the employee task. In one of these embodiments, by way of example, the object management module 204 associates a file, including a description of the task, with the identification of the employee task. In another of these embodiments, the object management module 204 associates a file including a description of an employee assigned to the task. In still another of these embodiments, the object management module 204 associates a file including a calendar event with the employee task. In yet another of these embodiments, the object management module 204 associates meeting notes, comments, instructions, or other files with the employee task.

In some embodiments, the object management module 204 associates an identification of a meeting with the employee task. In one of these embodiments, a data structure 232d stores the identification of the meeting. In another of these embodiments, when a user attends a physical or virtual meeting, she may volunteer for or be assigned one or more tasks. In such an embodiment, when the user accesses the object management module 204 to associate herself with a task, or to associate another user with a task, she may also identify goals or objectives explicitly or implicitly associated with or furthered by the task, as well as associate the meeting with the task. In such an embodiment, the system provides functionality for maintaining a link between a task or goal back to the meeting in which it was discussed. Furthermore, in such an embodiment, other meeting attendees associated with the identification of the meeting, which is then associated with the employee task assigned at the meeting, may receive notifications of status updates for the employee task, providing functionality for maintaining or improving a meeting attendee's level of understanding of what has transpired since the meeting. In some embodiments, meeting attendees may review objects associated with the meeting (such as employee tasks assigned at the meeting) by viewing the meeting data, even after the meeting has concluded. In this way, users may view outstanding tasks (their own or others′), follow-up meetings, and other meeting-related data.

Referring now to FIG. 3E, a block diagram depicts one embodiment of a user interface 330 for receiving text to associate with an object. In some embodiments, as indicated above, the object management module 204 associates text with an object. In one of these embodiments, the text includes a comment or note. In another of these embodiments, the text is a blog post, which may also be referred to as a story. In still another of these embodiments, when users view the object (e.g., a goal), they may also view the text (e.g., a story, by a user connected with the object, about the experience of working on the object). In yet another of these embodiments, the system may provide an interface (not shown) with which users may view a plurality of stories generated throughout an organization (e.g., a blog).

Referring back to FIG. 3A, the method 300 includes providing, by the first computing device, to a third computing device, an identification of the modified status of the objective (312). In one embodiment, the data visualization module 210 provides the identification. In another embodiment, the data visualization module 210 provides access to a visualization of the status of the goal. In still another embodiment, the data visualization module 210 provides access to a visualization of the status of the employee task. In yet another embodiment, the data visualization module 210 provides access to a visualization of the status of the objective.

In one embodiment, the system 200 provides functionality allowing for the synchronization of events across multiple users in an organization. For example, in an embodiment in which a first user is associated with a first goal and a second user is associated with a second goal, when the first user updates the first goal, the status module 206 may transmit a notification of the update to the second user. In one embodiment, the status module 206 identifies users that have registered for notification of updates to the first goal. For example, when the second user accessed a visualization of the first goal provided by the data visualization module 210, the second user may have registered for notifications. In some embodiments, the second user accesses the visualization using a web browser executing on the computing device 102 and the web browser receives an instruction to register the second user for notifications and transmits the instruction to the object management module 204 executing on the computing device 106. Upon receiving the instruction, the object management module 204 adds an identification of the second user to an enumeration of users registered for notifications relating to the first goal. When the status module 206 receives an identification of a status update from the first user, the status module 206 retrieves the enumeration of registered users and transmits the update notification to each of the enumerated registered users, including the second user. In some embodiments, the registration instruction includes a time period for which the registration is in effect; for example, the registration may be valid while the second user is accessing the visualization of the first goal, while the second user is authorized to view the first goal, while the second user is associated with a task or goal associated with the first goal, or other administrator-specified period of time.

In some embodiments, when a first user registers for update notifications associated with a second user, the object management module 204 transmits data associated with the second user to a computing device 102 of the first user where the computing device 102 caches the transmitted data. In the event that any user updates the data associated with the second user, the first user's computing device 102 is notified of the update, invalidates the cached data, and retrieves the updated data.

In some embodiments, the analysis module 208 provides functionality for forecasting object completion dates. In one of these embodiments, the analysis module 208 analyzes a length of each task or goal aligned to a goal to forecast a completion date for the goal. In another of these embodiments, the analysis module 208 analyzes a length of each task or goal upon which a goal depends in order to forecast a completion date for the goal. In still another embodiment, the analysis module 208 analyzes a level of likelihood that individuals associated with the goal will achieve the goal and any sub-goals or tasks by analyzing historical performance of each individual.

In other embodiments, the analysis module 208 provides functionality for mathematically determining a level of effort required to complete a goal. In one of these embodiments, the analysis module 208 determines a percentage of a user's total “personal effort” toward each of his goals and executes a method to incorporate that percentage into an analysis of an entire organization so that users can understand the total allocation of “corporate effort” for resources against each of an organization's goals. In another of these embodiments, the analysis module 208 analyzes a prioritization level of each of a plurality of goals and the estimated completion dates for each of the plurality of goals, as well as a level of alignment to an overarching goal or objective, and applies an algorithm to allocate personal effort between those goals based proportionally on their priority and then incorporates the total portions of personal effort across multiple users for a view of corporate effort against the corporate goals. In still another of these embodiments, the data visualization module 210 provides a visualization of the results of the analyses performed by the analysis module 208 and allows users to model the results of various corporate decisions on effort and progress towards goal completion. For example, the data visualization module 210 may provide access to a visualization based on an analysis by the analysis module 208 for a particular set of corporate decisions; by allowing a user to modify aspects of the visualization (modifying a level of prioritization, for example, or adding or removing goals or tasks) and then re-executing the analyses by the analysis module 208, the system 200 allows a user to model the impact of different decisions. The data visualization module 210 may further allow a user to specify different algorithms with which the analysis module 208 should perform the analyses, allowing for additional data modeling. In some of these embodiments, data modeling may be used to mathematically determine goal effort in situations including, without limitation:
Where that effort is calculated algorithmically;
   Where the greater or lesser effort is determined using the Fibonacci sequence.
   Where it is determined using long tail analysis—head, shoulders, and long tail.
   Where it is a combination of the above and time keeping.
   Where the system determines which goals or projects have the most tasks associated with them.
      Where those tasks have effort associated with them.
   Where the system asks users to estimate the amount of effort they are applying to each of their goals or asks them to estimate the amount of effort they are applying to projects or tasks, which are then rolled up into goals.
   Where the system checks the accuracy with the users and crowd-sources improved accuracy of goal priority to effort through asking if it is calculating it appropriately.
   Where the methods are regressed and tested per industry and the company is offered a series of coefficients that will provide the most optimized version of the algorithm for its own needs.
Where that effort can be combined with effort of other goals based on their relationships (alignment, dependencies, etc.) to calculate the total corporate effort associated with a goal;
Users can multiply this by the salaries of the employees working on aligned goals over the period of time they are working on the goal and percent of effort allocated to that goal to determine the cost of the goal;
   Users can roll up the aligned percentage of all employee effort to determine the equivalent number of employees working on a goal as if the rolled up percentages of people's effort were employees in the organization, resulting in an identification of “focused headcount.”
      Users can use this to calculate the average cost of the employee focused on a goal.
   Users can divide the total cost of the goal by the goal output to determine the return on investment.
Once the effort is rolled up by the goals to which they are aligned, users can:
   Prioritize focus on goals by changing the order of priority individually or in bulk of the aligned goals, adding or reducing headcount focused on goals or adding or deleting goals altogether;
   Determine the amount of effort allocated to goals that are not aligned to an organizational strategy (determine waste through goals, projects or tasks that are not aligned with a plan);
   Determine the man months focused on each goal; and
   Approve or hold hiring against goals instead of by department or other means.
If users allow people to connect to more than one goal, the algorithms would still allow users to see how people are focused based on sub-dividing the smaller set of goals.

In some embodiments, the analysis module 208 allows users to measure effort related to one or more goals without requiring users to log their time. By analyzing desired delivery date for identified goals and the percentage of time users have committed to achieving each of the identified goals, the analysis module 208 can identify the focused effort.

As an illustrative example, and without limitation, in an embodiment in which a company wants to achieve three goals and has three people, the analysis module 208 may examine how much effort is belong applied to each goal and with that focus, the analysis module 208 can identify the timelines in which each person expects to accomplish their goal. Continuing with this example, three sample goals may be: Goal 1=Save six monkeys from the zoo; Goal 2=Eat 20 bananas; and Goal 3=Make one million dollars. Continuing with this example, Person 1 may have chosen to dedicate 60% of his effort on goal 1 to achieve it in 3 months, 30% on goal 2 to achieve it in 5 months, and 10% on goal 3 in 10 months; Person 2 may have chosen to dedicate 100% on goal 1 to achieve their part in 6 months; and Person 3 may have chosen to dedicate 40% on goal 1 to achieve their part in 8 months, 60% on goal 2 to achieve it in 5 months and 0% on goal 3. In this example, the analysis module 208 may combine the focused goals, and maximum timelines across each person and their goals to derive the following focused headcount: Goal 1=2 People, in 8 months; Goals 2=0.9 People, in 5 months; and Goal 3=0.1 People, in 6 months. From a focused headcount, the analysis module 208 can derive Key Performance Indicators. For example, the analysis module 208 can determine the man months dedicated to the project: Goal 1=16 Months; Goal 2=5 months; and Goal 3=1 Month. In an embodiment where the analysis module 208 completes an analysis based on employee salaries, the analysis module 208 can determine the cost of each goal. For example: Person 1=300K, Person 2=200K, Person 3=100K; 0.6*300K*(3/12)+1*200K*1+0.4*100K*(8/12)=n; and the return on investment would be n/6=50K/monkey.

In addition to allowing a user to model goal efforts, the analysis module 208 allows users to measure alignment and drift and their impact on organizational performance By providing users with an interface for real-time analysis and visualization of an impact of a modification to one or more objects—such as a modification to a prioritization level for a task, a goal or an objective—the analysis module 208 and data visualization module 210 provide users with increased visibility into the impact of management decisions. As opposed to conventional environments, in which goals typically cascade through management without visibility into the real alignment of what employees work on versus what management expected, the methods and systems described herein provide clarity as to how closely aligned employee work is to management expectations and the impact on the employees of a modification by management to various expectations. In one embodiment, the analysis module 208 executes a method for estimating the transparency of an organization to company leadership based on an equation where Transparency=Average span of Control̂Levels of Visibility (T=ĈL/S) in the organization/size of the organization in people. Using this equation, the analysis engine 208 may determine a level of transparency and visibility that a user assigned to a high-level objective (such as a company executive) has into lower-level tasks (such as employee tasks for carrying out goals that will implement the objectives). By way of example, in an organization with 1000 people and an average span of control of 10, where an executive can see two levels deep, there is a level of visibility substantially equal to 10%. To improve the level of visibility by even one level would raise transparency to 100% transparency in an organization where 90% of the organization sits three levels beneath the chief executive officer. In one embodiment, therefore, the analysis module 208 executes a method for computing the improvement in transparency of an organization based on the total number of people in an organization divided by the number of people who have begun to map their goals to the organization's goals. In some embodiments, the use of the methods and systems described herein to provide a visualization of goals at each level and increase the level of visibility available to a user may result in increased transparency for company executives.

In some embodiments, the methods and systems described herein allow users to mathematically improve organizational design. In one of these embodiments, by laying goals and their dependencies on top of a corporate organizational chart and understanding the properties of the people involved (location and department), the analysis module 208 can map the degrees of separation between the parties who have dependencies. In another of these embodiments, the analysis module 208 can give the goals and dependencies constraints and then run them through one or more optimization scenarios. Through this process, the analysis module 208 may generate alternative organizational structures and compute the cost of those structures in order to determine if there are structures that reduce costs of complexity as compared to the current organizational structures. In one embodiment, there are three degrees of separation between dependencies in an organization:
Hierarchical—Degrees of separation of management between two dependent goals;
Physical—Degrees of separation between where two dependencies are located in the physical world; and
Structural—Degrees of separation between cost centers, departments, clients served.

In another embodiment, organizations can simplify their structures logically and mathematically by reducing these degrees of separation, while maintaining best practices such as span of control and key employees. In still another embodiment, one approach to simplification is to evaluate scenarios using a Monte Carlo simulation, which reviews random scenarios available within given constraints and friction coefficients placed on the type of separation. For example, in some embodiments, the most efficient organization with the fewest degrees of separation would be one with every person in the organization reporting to the CEO; however, as this example illustrates, constraints such as span of control and levels in the organization should be applied to account for human capacity for management. In one embodiment, this method decreases headcount in a company while simplifying the structure and preventing loss of effort against the company's most important goals. Examples of simulation inputs, constraints, and visual outputs include, without limitation:
Examples of Constraints
   Degrees of separation—Allow 3-6 degrees of separation.
   Goal constraints—Only allow resources who are 90% focused on goals with priority 3 or above. Do not remove any resources that are focused on goals with priority 1 (or most important).
   Separation constraints—For example, office, geography, cost, departmental. People physically remain in one or more of their constraints.
   Span of control—Set the span of control at either a user-selected level or a default suggestion (e.g., maximum span of control at 4 and the minimum at 6).
   Reductions in Force (RIFs)—occurring when a user needs to remove between X and Y number of people from the organization, and may include (0-N) costs.
   Performance—Typical users would prefer management by A players over B and C players.
   Level Changes—In some embodiments, users specify that people can only move n levels in the organization in order to simplify the organizational structure.
Examples of Friction Coefficients
   Physical—users may specify, for example, that it is 2× worse if someone is in a different time zone than if the same person is on a different floor of a particular office.
   Hierarchical—users may specify, for example, that it is 2× worse if a degree of separation must flow through a level 1 manager.
Examples of Visualization Inputs, which help define the problem set a user visualizes
   Level Granularity—users may specify a level within the organization to which to roll the dependencies up (1-N).
   Type of separation—users may specify geographic, cost center, departmental, division, or other organizational structure.
   Degrees of separation—users may specify that the system should display only the dependencies that are over N degrees.
   Resolution Level—users may specify that the system should display only separations that pass through a particular level.
   Goals impacted—users may specify that the system should display the goals that will be eliminated and the percent impact on the remaining goals.

In some embodiments, the analysis module 208 may algorithmically compute a number that represents the management complexity of the chosen organizational structure by mapping the degrees of separation of all the dependencies represented and thus suggest the best outcome or series of outcomes from which to choose. In one of these embodiments, the analysis module 208 could use that number to benchmark an organization against organizations of similar size.

Referring now to FIG. 4A, a flow diagram depicts one embodiment of a method for real-time alignment of a job opportunity to a corporate objective. The method 400 includes associating, by a first computing device, a goal with a corporate objective (402). The method 400 includes associating, by the first computing device, an employee task with the goal (404). The method 400 includes receiving, by the first computing device, from a second computing device, an indication that the employee task is incomplete (406). The method 400 includes associating, by the first computing device, the goal and the employee task with a description of a job opportunity (408). The method 400 includes providing, by the first computing device, to a third computing device, an indication that the goal and the employee task are incomplete and the description of the job opportunity (410).

In some embodiments, the methods and systems described herein enable users to contextualize parts of a human resources process. In one of these embodiments, the methods and systems described herein allow users to create and align the goals of a future employee before a person is hired for the role, so that users throughout the organization understand the impact of a potential candidate on the goals of a company before the candidate is approved or hired. In another of these embodiments, the data visualization module 210 provides a visualization of goals associated with future employees. In still another of these embodiments, the data visualization module 210 provides a visualization of goals associated with a job description. Such visualizations may provide an indication of the areas where existing employees are trying to hire new resources and would allow existing employees to make hiring decisions based on the impact of the goals potential candidates would perform in the job. Furthermore, such visualizations may enable new hires to be trained and prepared (e.g., onboarded) directly into the goals that were created for them providing immediate context for the role. Additionally, once completed, those goals can be applied with feedback, recognition, and 360 reviews directly back into the employee performance review.

Referring to FIG. 4A, and in greater detail, the method 400 includes associating, by a first computing device, a goal with a corporate objective (402). In some embodiments, the computing device 106 makes the association as described above in connection with FIG. 3 (302).

The method 400 includes associating, by the first computing device, an employee task with the goal (404). In some embodiments, the computing device 106 makes the association as described above in connection with FIG. 3 (304).

The method 400 includes receiving, by the first computing device, from a second computing device, an indication that the employee task is incomplete (406). In some embodiments, a user evaluating whether to create a new job opportunity first identifies what incomplete tasks, projects or goals the new hire would complete. For example, before hiring a new employee, an administrator (e.g., a human resources employee or an executive) may identify incomplete employee tasks and provide an opportunity for existing employees to volunteer to complete the tasks and, in some embodiments, receive additional credit, bonuses, or other recognition in exchange.

The method 400 includes associating, by the first computing device, the goal and the employee task with a description of a job opportunity (408). In some embodiments, in addition to creating a job description for a new hire, the individuals requesting the new hire (e.g., executives or managers) provide an identification of the incomplete tasks that the new hire would be assigned to complete; in such an embodiment, managers have an opportunity to identify and approve hiring decisions based on the specific tasks and goals that will be accomplished as opposed to vague titles or job descriptions.

The method 400 includes providing, by the first computing device, to a third computing device, an indication that the goal and the employee task are incomplete and the description of the job opportunity (410). In some embodiments, the method includes modifying, by the first computing device, a status of the goal responsive to the received identification. In other embodiments, the method includes modifying, by the first computing device, a status of the objective responsive to the modification of the status of the goal. In such embodiments, the data visualization module 210 is able to provide a visualization of the impact not hiring someone to complete the employee task has on the organization as a whole. In some embodiments, the visualization may be provided to a potential candidate, allowing the candidate to better understand what tasks and goals they will be contributing to if they are hired.

Referring now to FIG. 4B, a block diagram depicts one embodiment of a user interface 420 with which a user may associate objects with a new hire. As depicted in FIG. 4B, the user interface 420 may provide the user with functionality for assigning tasks to the new hire. The user interface 420 may provide the user with functionality for creating or modifying a new hire information packet. The user interface 420 may provide the user with functionality for transmitting an identification of the assigned task or tasks to the new hire.

In addition to generating job descriptions associated with specific tasks and goals for completion by potential candidates, in some embodiments, the methods and systems described herein provide functionality for evaluating performance of employees based on the employee contributions to the tasks and goals they were hired to complete. In one of these embodiments, the analysis module 208 attributes goal performance to the users who are working on or are aligned to the goals. For example, the system 200 may generate a log of a user's performance based on goals the user achieved (e.g., in terms of how well the user met deadlines and published status updates).

In another of these embodiments, the analysis module 208 evaluates performance (as indicated, for example, by how much progress a particular user has made towards an assigned goal or task). In still another of these embodiments, therefore, organizational structure is based on an allocation of high and low performing individuals to goals whereby the analysis module 208 can optimize the allocation of higher performing people to more important goals within given constraints. In another of these embodiments, the analysis module 208 examines the goal alignment, status of the goals aligned and an individual's historical success at achieving those goals and how that links to the performance “grade” people have been allocated during their performance reviews. In still another of these embodiments, the analysis module 208 attempts to draw conclusions from this process such as, “‘A’ players are two times more likely to achieve their goals on time.” Once these properties have been established, the analysis module 208 may use them to model new organizational structures that will improve overall performance by putting people who are good at achieving the results requested into roles that will leverage their abilities. In other embodiments, the analysis module 208 may use these properties to provide additional performance review data to evaluated individuals. In one of these embodiments, for example, the analysis module 208 may link goals that are completed in a certain time frame to a performance review process where individuals are evaluated on those goals. That linkage may bring data associated with goals (e.g., 360 reviews, peer reviews, and other feedback associated with those goals) into the performance review process, may allow reviews to be connected to public review locations (e.g., professional social media sites such as LinkedIn), and may allow performance reviews to be weighted appropriately (e.g., when receiving a review, the analysis module 208 may consider the annual performance of the employee providing feedback and weight the performance of the contributor accordingly).

Referring now to FIG. 4C, a block diagram depicts one embodiment of a user interface 430 for associating a goal with an employee review.

Referring now to FIG. 4D, a block diagram depicts one embodiment of a user interface 440 with which users may provide a review of an object. In one embodiment, using the user interface 440, users may review a goal, a task, or a meeting based on connected parties. In another embodiment, the system combines reviews of a level of performance of one or more connected parties to provide a review of the object. In still another embodiment, the system performs a particular type of review known as a 360 review. In such an embodiment, the system receives an identification of one or more users connected to an object and the system requests a review of the object by each of the one or more users.

Referring now to FIG. 4E, a block diagram depicts one embodiment of a user interface 450 that provides a data visualization allowing users to view goals and performance by users associated with those goals.

In some embodiments, the analysis module 208 includes functionality not only for linking goals, tasks, and other objects to user performance but for determining a level of employee satisfaction. In one of these embodiments, by analyzing user contributions—number and quality of status updates, comments on their own tasks and goals, comments on the tasks and goals of others, and other user-generated content—the analysis module 208 can conduct sentiment analysis to determine when an employee is dissatisfied or may be a potential risk for leaving the organization.

In some embodiments, in addition to creating goal-oriented job descriptions and evaluating hired employees based on performance in executing tasks and furthering objectives, the methods and systems described herein provide functionality for identifying opportunities for training and continuing education. In one of these embodiments, rather than having employees face the onerous or haphazard task of identifying and justifying expenses for training or continuing education opportunities, the analysis module 208 may identify tasks in which employees fell behind schedule or failed to complete the tasks due to insufficient training or time required to master particular skills, and the analysis module 208 may determine that similar employees may also require additional training in those skills. Similarly, the analysis module 208 may review data associated with an employee to determine whether the employee has the requisite skills for a particular task. Although in some embodiments the analysis module 208 may recommend assigning a different employee to a task, in other embodiments, the analysis module 208 may recommend providing additional training to an employee lacking a particular skill. Therefore, in some embodiments, the analysis module 208 provides recommendations for training or continuing education opportunities based on qualitative or quantitative analyses and, in conjunction with the data visualization module 210, provides a visualization of what employees would most benefit from training and how that training will further various tasks or goals.

Referring now to FIG. 5, a flow diagram depicts one embodiment of a method 500 for allocating priorities to goals. The method 500 includes associating, by a computing device, at least one employee with each of a plurality of goals (502). The method 500 includes determining, by the computing device, an allocation of personal effort of the at least one employee toward each of the plurality of goals (504). The method 500 includes determining, by the computing device, a corporate allocation of effort for each goal of the plurality of goals, using the determined allocation of effort for the at least one employee (506). The method 500 includes providing, by the computing device, to a user, a visualization of the determined corporate allocation of effort (508).

Referring now to FIG. 5, in greater detail and in connection with FIGS. 2A-S, the method 500 includes associating, by a computing device, at least one employee with each of a plurality of goals (502). In some embodiments, this is implemented as disclosed above in reference to FIG. 3A.

The method 500 includes determining, by the computing device, an allocation of personal effort of the at least one employee toward each of the plurality of goals (504). In some embodiments, this is implemented as disclosed above in reference to FIG. 3A. In some embodiments, the analysis module 208 determines the allocation of personal effort of the at least one employee by determining a percentage of effort the at least one employee has dedicated to each goal. The analysis module 208 may determine the percentage of effort the at least one employee has dedicated to the goal as described above in reference to FIG. 3A. In other embodiments, the analysis module 208 determines the allocation of personal effort of the at least one employee by determining a percentage of effort the at least one employee has dedicated to at least one task aligned with at least one of the plurality of goals and associated with the at least one employee; the analysis module may implement this as described above in reference to FIG. 3A. In additional embodiments, the analysis module 208 determines the allocation of personal effort of the at least one employee by analyzing a prioritization level of each of the plurality of goals and an estimated completion date for each of the plurality of goals, analyzing a level of alignment of each of the plurality of goals to at least one of an overarching goal and an overarching objective, and allocating personal effort between those goals based proportionally on their priority. The analysis module may implement this as described above in reference to FIG. 3A.

The method 500 includes determining, by the computing device, a corporate allocation of effort for each goal of the plurality of goals, using the determined allocation of effort for the at least one employee (506). In some embodiments, this is implemented as disclosed above in reference to FIG. 3A. In some embodiments, the analysis module 208 determines the corporate allocation of effort by determining that a first goal of the plurality of goals depends on a second goal of the priority of goals, determining a corporate allocation of effort to the second goal, and including the effort allocated to the second goal in the calculation of the effort allocated to the first goal. The analysis module may implement this as disclosed above in reference to FIG. 3A. In other embodiments, the analysis module 208 determines the corporate allocation of effort by multiplying a salary of each employee working on one of the plurality of goals by a percent of effort allocated to that goal by that employee, and determining the cost of the goal based upon the multiplication; the analysis module 208 may implement this as described above in reference to FIG. 3A. In additional embodiments, the analysis module 208 determines the corporate allocation of effort to one of the plurality of goals determining the man-months currently allocated to the goal, as set forth above in reference to FIG. 3A.

The method 500 includes providing, by the computing device, to a user, a visualization of the determined corporate allocation of effort (508). In some embodiments, this is implemented as disclosed above in reference to FIG. 3A.

Some embodiments of the method 500 also include attributing, by the computing device, to the at least one employee, a level of performance on one of the plurality of goals, evaluating, by the computing device, the level of performance, and providing a data visualization modeling an organizational structure for improving the determined corporate allocation of effort towards one of the plurality of goals based upon the level of performance of the at least one employee. In some embodiments, the analysis module 208 implements this as described above in reference to FIGS. 4A-4E. The analysis module may further generate a log of the at least one employee's performance based on goals achieved by the at least one employee, as disclosed above in reference to FIGS. 4A-4E. In some embodiments, the analysis module 208 evaluates how much progress the at least one employee has made towards one of the plurality of goals. The analysis module may evaluate progress as disclosed above in reference to FIGS. 4A-4E. In additional embodiments, the analysis module 208 allocates one of the plurality of goals to the at least one employee based on the evaluation, as set forth above in reference to FIGS. 4A-4E. The analysis module 208 may provide a data visualization allowing the user to view at least one of the plurality of goals and the evaluated performance of each employee associated with the at least one of the plurality of goals. In some embodiments, the provision of the data visualization is performed as described above in reference to FIGS. 4A-4E.

Some embodiments of the method 500 further involve receiving, from the user, an instruction modifying a level of prioritization of one of the plurality of goals and reanalyzing the plurality of goals to determine the corporate allocation of effort to each goal. In some embodiments, this is implemented as described above in reference to FIG. 3A. Some embodiments further include receiving, from the user, an instruction removing at least one of the plurality of goals and reanalyzing the plurality of goals to determine the corporate allocation of effort to each goal. In some embodiments, this is performed as disclosed above in reference to FIG. 3A. Some embodiments further involve receiving, from the user, an instruction adding a new goal to the plurality of goals and reanalyzing the plurality of goals to determine the corporate allocation of effort to each goal, as described above in reference to FIG. 3A. In some embodiments, the analysis module 208 receives, from the user, an instruction removing a goal from the plurality of goals and reanalyzes the plurality of goals to determine the corporate allocation of effort to each goal. The analysis module 208 may implement this as described above in reference to FIG. 3A. In an additional embodiment, the analysis module 208 receives, from the user, an instruction associating new task assigned to the at least one employee for one of the plurality of goals and reanalyzes the plurality of goals to determine the corporate allocation of effort to each goal; the analysis module 208 may receive the instruction and reanalyze the plurality of goals as disclosed above in reference to FIG. 3A. In further embodiments, the analysis module 208 determines that at least one goal is not aligned to an organizational strategy. The analysis module 208 may implement this as described above in reference to FIG. 3A. In some embodiments, the reanalysis described herein results in automatic reprioritization of goals and priorities throughout the organization.

Some embodiments involve providing to the user a visualization modeling an impact of the received instruction on the determined effort. In some embodiments, this is implemented as described above in reference to FIG. 3A. Other embodiments further include that at least one goal is not aligned to an organizational strategy. This may be implemented as disclosed above in reference to FIG. 3A. Another embodiment involves calculating, based on the identification, a corporate allocation of effort to goals not aligned with organizational strategies. This may be implemented as disclosed above in reference to FIG. 3A.

As indicated above, in some embodiments, implementation of the methods and systems described herein may provide, to employees at all levels of an organization, increased transparency as to a level of progress and an understanding of what specific tasks prevent or promote completion of goals and alignment to organizational objectives.

The following illustrative example shows how the methods and systems discussed above can be used to provide real-time measurement of progress on employee tasks aligned to a corporate objective. This example is meant to illustrate and not to limit the invention.

### a Goal-Based System Aligned to Corporate Objectives Through a Corporate Hierarchy to Enable Workflows

In one embodiment, the system 200 receives a request to hire an employee, the request including one or more goals that the new employee would be assigned to complete. The system 200 receives instructions for aligning the goals in the request with one or more goals assigned to a user who would manage the new employee. The system 200 may receive, from a user responsible for approving hiring decisions, an indication of a decision to approve the request, which may be, for example, based on either management goals or the employee-level goals. The system 200 may alternatively receive, from the user responsible for approving hiring decisions, an indication of a decision to deny the request. In the event of an approval of the hiring request, the system 200 may transition the one or more goals from potential goal(s) to actual goal(s) assigned to the new employee. In such an embodiment, the goal(s) become the fabric of the job description that also includes additional information around the new employee's manager, peers, direct reports, and the broader ecosystem into which the new employee is integrating, all of which may be used to generate a more compelling offer than a conventional job offer. Similarly, in such an embodiment, a training process for the new employee (also referred to as an onboarding process) includes displaying the assigned goal(s) directly to the new employee, providing the new employee with the ability to more rapidly understand the context of her job. Furthermore, the assigned goal(s) may be modified throughout the year instead of being set and reviewed on a quarterly or bi-annual basis as is more conventional; goals that may dynamically change in response to changes in corporate objective may allow the new employee better visibility into her alignment to the organization's broader goals than a conventional environment in which an employee may work for substantial periods of time only to learn that work is no longer a priority to the organization. Similarly, the system 200 allows users, such as the new employee, to more easily identify appropriate reviewers for performance reviews—and the system 200 may, in some embodiments, recommend the appropriate users to complete the review to the employee instead of the employee having the burden of identifying the appropriate users. Additionally, the system 200 allows users to base performance reviews on a more complete data set than just what a particular user recalls about another user's performance on a task, project, goal, or other object—the system 200 may incorporate a history of the object, corresponding objects, reviews of other users, peer reviews of the user being reviewed, tasks assigned, delegated, and modified during the course of work, notes, stories, and other data associated with the user and the object to create a closed loop system for helping users review employees.

Although described herein in the context of organizations in which members are employers and employees, it should be understood that the methods and systems described herein may be implemented by any groups of individuals seeking to execute tasks in order to achieve common goals and shared objectives.

It should be understood that the systems described above may provide multiple ones of any or each of the described components and that these components may be provided on either a standalone machine or, in some embodiments, on multiple machines in a distributed system. It should also be understood that phrases such as “based on” and “based upon” do not imply “based exclusively on” and instead generally mean that the particular feature, structure, step, or characteristic is based at least in part on the specified element. Further, the phrases ‘in one embodiment,’ in another embodiment,′ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, Python, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for understanding the allocation of resources to goals, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for understanding the allocation of resources to goals, the method comprising:
associating, by a computing device, at least one employee with each of a plurality of goals;
determining, by the computing device, an allocation of personal effort of the at least one employee toward each of the plurality of goals;
determining, by the computing device, a corporate allocation of effort for each goal of the plurality of goals, using the determined allocation of effort for the at least one employee; and
providing, by the computing device, to a user, a visualization of the determined corporate allocation of effort.

2. The method of claim 1, wherein determining the allocation of personal effort of the at least one employee further comprises determining a percentage of effort the at least one employee has dedicated to each goal.

3. The method of claim 1, wherein determining the allocation of personal effort of the at least one employee further comprises determining a percentage of effort the at least one employee has dedicated to at least one task aligned with at least one of the plurality of goals and associated with the at least one employee.

4. The method of claim 1, wherein determining the allocation of personal effort of the at least one employee further comprises:
analyzing a prioritization level of each of the plurality of goals and an estimated completion date for each of the plurality of goals;
analyzing a level of alignment of each of the plurality of goals to at least one of an overarching goal and an overarching objective; and
allocating personal effort between those goals based proportionally on their priority.

5. The method of claim 1, wherein determining the corporate allocation of effort further comprises:
determining that a first goal of the plurality of goals depends on a second goal of the priority of goals;
determining a corporate allocation of effort to the second goal; and
including the effort allocated to the second goal in the calculation of the effort allocated to the first goal.

6. The method of claim 1, wherein determining the corporate allocation of effort further comprises:
multiplying a salary of each employee working on one of the plurality of goals by a percent of effort allocated to that goal by that employee; and
determining the cost of the goal based upon the multiplication.

7. The method of claim 1, wherein determining the corporate allocation of effort to one of the plurality of goals further comprises determining the man-months currently allocated to the goal.

8. The method of claim 1 further comprising:
attributing, by the computing device, to the at least one employee, a level of performance on one of the plurality of goals;
evaluating, by the computing device, the level of performance;
providing a data visualization modeling an organizational structure for improving the determined corporate allocation of effort towards one of the plurality of goals based upon the level of performance of the at least one employee.

9. The method of claim 8, wherein attributing further comprises generating a log of the at least one employee's performance based on goals achieved by the at least one employee.

10. The method of claim 8, wherein evaluating further comprises evaluating how much progress the at least one employee has made towards one of the plurality of goals.

11. The method of claim 8 further comprising allocating one of the plurality of goals to the at least one employee based on the evaluation.

12. The method of claim 8 further comprising providing a data visualization allowing the user to view at least one of the plurality of goals and the evaluated performance of each employee associated with the at least one of the plurality of goals.

13. The method of claim 1 further comprising:
receiving, from the user, an instruction modifying a level of prioritization of one of the plurality of goals; and
reanalyzing the plurality of goals to determine the corporate allocation of effort to each goal.

14. The method of claim 1 further comprising:
receiving, from the user, an instruction removing at least one of the plurality of goals; and
reanalyzing the plurality of goals to determine the corporate allocation of effort to each goal.

15. The method of claim 1 further comprising:
receiving, from the user, an instruction adding a new goal to the plurality of goals; and
reanalyzing the plurality of goals to determine the corporate allocation of effort to each goal.

16. The method of claim 1 further comprising:
receiving, from the user, an instruction associating a new task assigned to the at least one user for one of the plurality of goals; and
reanalyzing the plurality of goals to determine the corporate allocation of effort to each goal.

17. The method of claim 16 further comprising:
providing to the user a visualization modeling an impact of the received instruction on the determined effort.

18. The method of claim 1 further comprising:
determining that at least one goal is not aligned to an organizational strategy.

19. The method of claim 18 further comprising calculating, based on the identification, a corporate allocation of effort to goals not aligned with organizational strategies.

20. A system for allocating priorities to goals, the system comprising:
an object management module, executing on a computing device and associating at least one employee with each of a plurality of goals;
an analysis module, executing on the computing device, determining an allocation of personal effort of the at least one employee toward each of the plurality of goals, and determining a corporate allocation of effort for each goal of the plurality of goals, using the determined allocation; and
a data visualization module, executing on the computing device and providing a visualization of the determined corporate allocation of effort to a user.
